(19) United States
(12) Patent Application Publication
(10) Pub. No.: US 2026/0004461 A1
(43) Pub. Date: Jan. 1, 2026

(54) BINOCULAR STEREO VISION FOR GROUND TRUTH DATA COLLECTION IN MONOCULAR ADAS CAMERA SCENE RECONSTRUCTION

(71) Applicant: Ambarella International LP, Santa Clara, CA (US)

(72) Inventor: Luyi Sun, Shanghai (CN)

(21) Appl. No.: 18/764,256

(22) Filed: Jul. 4, 2024

(30) Foreign Application Priority Data
Jun. 27, 2024 (CN) 202410850483.8

(51) Int. Cl. G06T 7/80; G06V 20/56; G06V 20/58

(52) U.S. Cl. CPC G06T 7/85; G06V 20/58; G06V 20/588

(57) ABSTRACT

An apparatus includes a chassis and a processor. The chassis may be configured to be mounted to a vehicle and to hold a first ADAS camera and a second ADAS camera. The chassis generally provides a coarse alignment of the first ADAS camera and the second ADAS camera to obtain stereo images of an area outside of the vehicle. The processor may be configured to (i) generate a frame synchronization signal based on a real-time clock signal, (ii) present the frame synchronization signal and one or more control signals to the first ADAS camera and the second ADAS camera, (iii) receive a first pixel datastream corresponding to the area outside of the vehicle from the first ADAS camera, (vi) receive a second pixel datastream corresponding to the area outside of the vehicle from the second ADAS camera, (v) process the first pixel datastream arranged as first video frames and the second pixel datastream arranged as second video frames, (vi) compute warp parameters for the first ADAS camera and the second ADAS camera to finely align pixel data of the first video frames with pixel data of the second video frames, and (vii) generate ground truth data based on the first video frames from the first ADAS camera and the second video frames from the second ADAS camera.

This application relates to China Application No. 202410850483.8, filed on June 27, 2024. The mentioned application is hereby incorporated by reference in its entirety.

### FIELD OF THE INVENTION

The invention relates to automated driver assistance systems generally and, more particularly, to a method and/or apparatus for implementing binocular stereo vision for ground truth data collection in monocular advanced driver assistance systems (ADAS) camera scene reconstruction.

### BACKGROUND

Some advanced driver assistance systems (ADAS) do not have a ground truth system. Without the ground truth system, an ADAS algorithm often estimates a height of a target object, then calculates a distance based on the geometric perspective relationship, which depends on static scene measurement and calibration. This method has a larger distance detection error when estimation of target object height is inaccurate, and when a road surface has bumps or slopes.

Some advanced driver assistance systems use LiDAR for the ground truth system. However, LiDAR has limitations. The scanning lines of LiDAR are relatively sparse. For example, a typical LiDAR has 128 scan lines, while the latest cutting edge LiDAR has 512 scan lines and is very expensive. Because the scanning lines of LiDAR are relatively sparse, points mapped by LiDAR on small long-distance targets are not dense enough to match an image resolution provided by ADAS cameras. Detecting long-distance targets with low reflectivity using LiDAR is difficult. Also, the field-of-view (FOV) and installation location of LiDAR are generally different from those of ADAS cameras. After correction, there is some FOV loss and point cloud reduction from LiDAR data. In addition, LiDAR generally has a relatively low frame rate (usually 10FPS) and cannot match each frame of video (video generally uses 30FPS). Therefore, the number of frames of data from LiDAR is fewer than the number of video frames for a given scene, which is not good when the vision algorithm needs consecutive frames of data with ground truth.

The cost of LiDAR-based ground truth systems is high. Customizing LiDAR-based ground truth systems for product needs can take a lot of time. Thus, LiDAR-based ground truth systems are difficult to use widely in ADAS.

It would be desirable to implement binocular stereo vision for ground truth data collection in monocular ADAS camera scene reconstruction.

### SUMMARY

The invention concerns an apparatus comprising a chassis and a processor. The chassis may be configured to be mounted to a vehicle and to hold a first ADAS camera and a second ADAS camera. The chassis generally provides a coarse alignment of the first ADAS camera and the second ADAS camera to obtain stereo images of an area outside of the vehicle. The processor may be configured to (i) generate a frame synchronization signal based on a real-time clock signal, (ii) present the frame synchronization signal and one or more control signals to the first ADAS camera and the second ADAS camera, (iii) receive a first pixel datastream corresponding to the area outside of the vehicle from the first ADAS camera, (vi) receive a second pixel datastream corresponding to the area outside of the vehicle from the second ADAS camera, (v) process the first pixel datastream arranged as first video frames and the second pixel datastream arranged as second video frames, (vi) compute warp parameters for the first ADAS camera and the second ADAS camera to finely align pixel data of the first video frames with pixel data of the second video frames, and (vii) generate ground truth data based on the first video frames from the first ADAS camera and the second video frames from the second ADAS camera.

### BRIEF DESCRIPTION OF THE FIGURES

Embodiments of the invention will be apparent from the following detailed description and the appended claims and drawings.

FIG. 1 is a diagram illustrating an example embodiment of the present invention configured to provide ground truth data for a forward-looking view of a vehicle.

FIG. 2 is a diagram illustrating a ground truth acquisition system in accordance with an example embodiment of the invention.

FIG. 3 is a block diagram illustrating an example implementation of a ground truth acquisition camera system in accordance with an example embodiment of the invention.

FIG. 4 is a diagram illustrating calibration of a ground truth acquisition device in accordance with an example embodiment of the invention.

FIG. 5 is a diagram illustrating disparity determination for a ground truth acquisition device in accordance with an example embodiment of the invention.

FIG. 6 is a diagram illustrating an object being imaged by cameras of a ground truth acquisition device in accordance with embodiments of the invention.

FIG. 7 is a diagram illustrating frames from the cameras of a ground truth acquisition device in accordance with embodiments of the invention imaging a common object.

FIG. 8 is a diagram illustrating a calibration process in accordance with embodiments of the invention.

FIG. 9 is a diagram illustrating a ground truth data acquisition process in accordance with embodiments of the invention.

### DETAILED DESCRIPTION OF THE EMBODIMENTS

Embodiments of the present invention include providing binocular stereo vision for ground truth data collection in monocular ADAS camera scene reconstruction that may (i) generate three-dimensional (3D) point cloud data that may be used as ground truth for monocular ADAS algorithm training, (ii) reduce costs by eliminating need for LiDAR, (iii) provide denser point cloud than LiDAR, (iv) utilize unaltered ADAS cameras, (v) improve distance accuracy of ADAS algorithms, (vi) provide binocular stereo detection of road curbs to facilitate improvement of monocular ADAS algorithms (e.g., for bumps and dips in a road), (vii) add precise world time, inertial data, and other information that enable more accurate scene reconstruction in post-processing, and/or (viii) be implemented as one or more integrated circuits.

In various embodiments, a ground truth acquisition device may be provided that creates a binocular stereo vision system with two monocular ADAS cameras. In an example, a ground truth acquisition device in accordance with an embodiment of the invention may perform CMOS sensor exposure synchronization through a frame synchronization signal (e.g., FSYNC), system time synchronization (e.g., via Ethernet, etc.), and acquisition of dual-channel encoded video from two ADAS cameras with timestamps (e.g., via Ethernet, etc.). In an example, the ground truth acquisition device generally comprises a processor (or system-on-chip (SoC)) that communicates with the two monocular ADAS cameras by a communication protocol. In an example, the communication protocol is generally agreed upon in advance, and may be implemented, for example, via an Ethernet interface. However, other interfaces may be implemented to meet design criteria of a particular implementation. In an example, the ground truth acquisition device may be configured to control two monocular ADAS cameras, including recording video, providing precise time synchronization, and obtaining real-time recorded video data (e.g., H.264/H.265, etc.).

In an example, the ground truth acquisition device may also be configured to perform a camera calibration based on the video/pictures collected by the two monocular ADAS cameras, so that the video generated by the two monocular ADAS cameras may be matched well in a stereo vision algorithm. In an example, the ground truth acquisition device may be configured to generate stereo vision disparity by stereo matching by itself. In another example, the ground truth acquisition device may be configured to generate disparity by storing data to memory (e.g., SSD, etc.), then exporting the data, and running the stereo matching algorithm on a remote system (e.g., offline). In an example, a point cloud may be calculated based on intrinsic parameters of the monocular ADAS cameras. The ground truth acquisition device may also be configured to store global positioning system (GPS) data and/or inertial measurement unit (IMU) data with timestamps, which may be helpful for post-processing (e.g., in scene reconstruction).

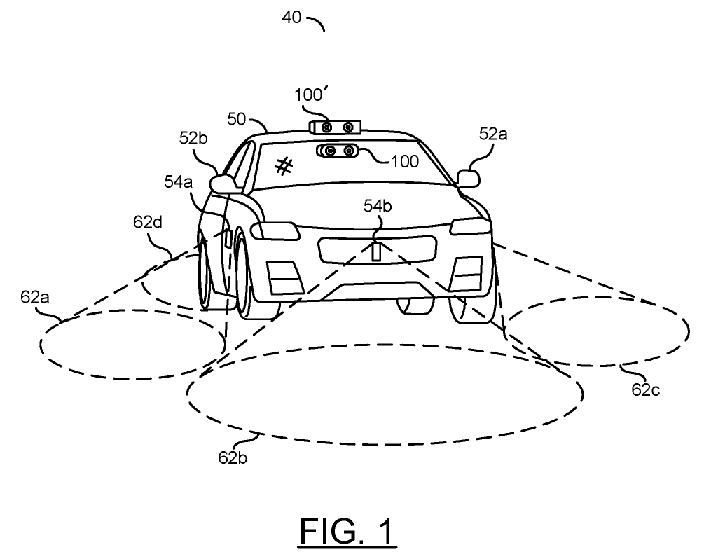

Referring to FIG. 1, a diagram is shown illustrating an example embodiment of a ground truth acquisition device in accordance with the present invention configured to provide ground truth data for a forward-looking view of a vehicle. An external view 40 for a vehicle 50 is shown. External side view mirrors 52a-52b are shown. The side view mirror 52a may be a side view mirror on the driver side of the vehicle 50. The side view mirror 52b may be a side view mirror on the passenger side of the vehicle 50. The vehicle 50 may comprise devices 54a-54n. The devices 54a-54n may be camera systems. Camera systems 54a-54b are shown integrated as part of the vehicle 50. The camera system 54a is shown on a passenger side of the vehicle 50. The camera system 54a is shown below the passenger side view mirror 52b. The camera system 54b is shown on the front grille of the vehicle 50. In the perspective of the vehicle 50 shown, two of the camera systems 54a-54b may be visible. However, one of the camera systems 54a-54n may be implemented at a level below the driver side view mirror 52a (not visible from the perspective of the external view 40 shown). Other camera systems 54a-54n may be located throughout the exterior of the vehicle 50. The camera systems 54a-54n may be configured to capture an all-around view of the environment 40 near the vehicle 50.

Dashed lines 62a-62d are shown. In the example shown, the dashed line 62a is shown extending from the camera system 54a and the dashed line 62b is shown extending from the camera system 54b. The dashed lines 62c and 62d may similarly extend from respective camera systems 54c and 54d (not visible from the perspective shown). The dashed lines 62a-62d may provide an illustrative representation of fields of view captured by each of the camera systems 54a-54d. The fields of view 62a-62d together may provide an all-around view of the environment near the vehicle 50.

The all-around view 62a-62d is shown. In an example, the all-around view 62a-62d may enable an all-around view (AVM) system. The AVM system may comprise four cameras (e.g., each camera may comprise a combination of one of the camera systems 54a-54n and/or a stereo pair of the lenses implemented by the camera systems 54a-54n). In the perspective shown in the external view 40, the camera system 54a and the camera system 54b may each be one of the four cameras and the other two cameras may not be visible. In an example, the camera system 54b may be a camera located on the front grille of the vehicle 50, one of the cameras 54a-54n may be on the rear (e.g., over the license plate), the camera system 54a may be located below the side view mirror 52b on the passenger side and one of the cameras 54a-54n may be located below the side view mirror 52a on the driver side. The arrangement of the cameras 54a-54n may be varied according to the design criteria of a particular implementation.

In some embodiments, each of the camera systems 54a-54d may be configured to capture pixel data arranged as video frames. In some embodiments, each of the camera systems 54a-54d providing the all-around view 62a-62d may implement a fisheye lens (e.g., may capture a video frame with a 180-degree angular aperture). The all-around view 62a-62d is shown providing a field of view coverage all around the vehicle 50. For example, the portion of the all-around view 62a may provide coverage for a passenger side of the vehicle 50, the portion of the all-around view 62b may provide coverage for a front of the vehicle 50, the portion of the all-around view 62c may provide coverage for a driver side of the vehicle 50 and the portion of the all-around view 62d may provide coverage for a rear of the vehicle 50. Each portion of the all-around view 62a-62d may be one field of view of a camera mounted to the vehicle 50. Each portion of the all-around view 62a-62d may be dewarped and stitched together by video processors to provide an enhanced video frame that represents a top-down view near the vehicle 50. In an example, the all-around view 62a-62d may be used to provide a representation of a bird’s-eye view of the vehicle 50.

The camera systems 54a-54d may provide a representative example of the mechanism for image acquisition. In one example, the camera systems 54a-54d may be implemented as monocular cameras. In another example, the camera systems 54a-54d may be implemented as stereo cameras (e.g., two capture devices implemented in a stereo pair). In some embodiments, the stereo cameras may be horizontally oriented. In some embodiments, the stereo cameras may be vertically oriented. In one example, four stereo cameras (e.g., eight capture devices) may be implemented, with one on each side of the vehicle 50. The locations of the camera systems 54a-54d on the vehicle 50 and/or the orientation of the camera systems 54a-54d may be varied according to the design criteria of a particular implementation.

In various embodiments, the vehicle 50 may be a light duty vehicle, a medium duty vehicle, a heavy duty vehicle, etc. The vehicle 50 may be implemented as an internal combustion engine (ICE) vehicle, a diesel vehicle, a hybrid electric vehicle, a battery electric vehicle, etc. The type of the vehicle 50 implemented may be varied according to the design criteria of a particular implementation.

In various embodiments, an apparatus 100 may be implemented as a ground truth acquisition device in accordance with an example embodiment of the invention. In an example, the ground truth acquisition device 100 may be mounted behind an inside surface of a windshield 70 of the vehicle 50 (e.g., right behind a rear view mirror). The ground truth acquisition device 100 may be installed to enable a field of view (FOV) of the ground truth acquisition device 100 to capture an environment through the windshield 70 toward the front end of the vehicle 50. In another example, a ground truth acquisition device 100’ may be implemented similarly to the ground truth acquisition device 100, except that the ground truth acquisition device 100’ may be configured to be mounted to an exterior surface (e.g., a roof, etc.) of the vehicle 50 (e.g., above a center the windshield 70 of the vehicle 50). The ground truth acquisition device 100’ may be installed to enable a field of view (FOV) of the camera system 100’ to capture the environment toward the front end of the vehicle 50.

The ground truth acquisition devices 100 and 100’ may be configured to acquire ground truth data about the environment in front of the vehicle 50 (e.g., detect people, objects, and/or animals that may be approaching the vehicle 50 from ahead). The implementation of the ground truth acquisition device 100/100’ and/or where the ground truth acquisition device 100/100’ is installed on the vehicle 50 may be varied according to the design criteria of a particular application. In some applications, multiple instances of the ground truth acquisition devices 100 and/or 100’ may be installed on the vehicle 50 to capture ground truth data for a 360-degree surround view application utilizing a plurality of monocular ADAS cameras.

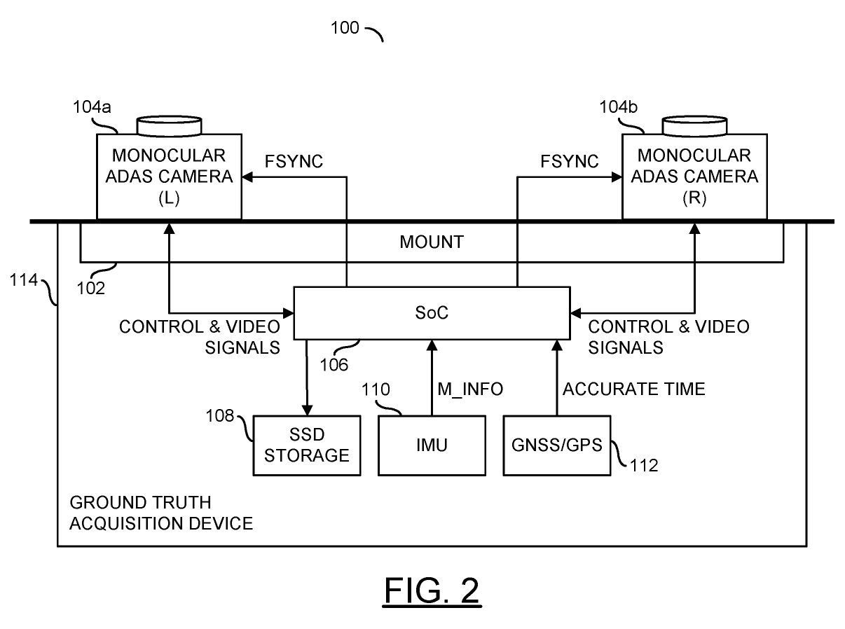

Referring to FIG. 2, a block diagram is shown illustrating a ground truth acquisition system in accordance with an example embodiment of the invention. In various embodiments, the ground truth acquisition device 100 may comprise a chassis structure (or camera mount) 102, two monocular ADAS cameras (or capture devices) 104a and 104b, a processor (or system-on-chip (SoC)) 106, and a memory 108. In various embodiments, the chassis structure 102 may comprise a metal frame that may be configured to accommodate the two monocular ADAS cameras 104a and 104b and interconnect multiple data interfaces. In an example, the two monocular ADAS cameras 104a and 104b may comprise identical monocular ADAS cameras. In various embodiments, the processor/SoC 106 may perform local data storage and time synchronization with the two monocular ADAS cameras 104a and 104b.

The two monocular ADAS cameras 104a and 104b, when mounted to the chassis structure 102, may be roughly aligned (e.g., parallel optical axes, etc.). In general, physically aligning the two monocular ADAS cameras 104a and 104b to the pixel level, which is very difficult to achieve, is not necessary. In an example, the chassis structure 102 may have some markings, slots, screws, and/or clamps to facilitate easy mounting of the two monocular ADAS cameras 104a and 104b. In an example, registration lines (or grooves) for aligning the two monocular ADAS cameras 104a and 104b may be marked (or etched) on the chassis structure 102. In an example, the chassis structure 102 may have rectangular or dovetail slots for aligning the two monocular ADAS cameras 104a and 104b. However, other types of markings and/or slots may be implemented to meet design criteria of a particular implementation. In an example, the two monocular ADAS cameras 104a and 104b may be placed or slid into the slots and locked in position on the chassis structure 102 (e.g., using screws, clamps, etc.). In various embodiments, the chassis structure 102 is generally configured to ensure that the optical axes of the two monocular ADAS cameras 104a and 104b are roughly aligned (e.g., parallel).

In various embodiments, a calibration process is generally performed after the ground truth acquisition device 100 has been physically mounted on a vehicle. In an example, a pre-calibration process may be performed after the two monocular ADAS cameras 104a and 104b have been physically mounted to the chassis structure 102, and before mounting the ground truth acquisition device 100 to a vehicle, to ensure the ground truth acquisition device 100 is operating. In general, the fine calibration of the cameras 104a and 104b is performed after the ground truth acquisition device 100 is mounted on a vehicle, because the mounting process may bring a subtle shift of the mechanical device, thus calibrating after mounting is more accurate. In an example, the calibration process generally comprises running stereo calibration using a test pattern (e.g., checkerboard, etc.) to determine a relationship between the two monocular ADAS cameras 104a and 104b and determining warp parameters to apply to each of the two monocular ADAS cameras 104a and 104b. In general, when the calibration is done, the warp parameters do not need to change until a big mechanical shift or change occurs. Then, calibration may be performed again.

In various embodiments, the warp parameters determined during the calibration process are generally communicated to image processing stages (or pipelines) within the two monocular ADAS cameras 104a and 104b. The image processing pipelines of the two monocular ADAS cameras 104a and 104b may then apply the warp parameters to respective captured images such that left and right images received by the processor/SoC 106 are fully aligned (e.g., both physically and temporally). After the warp parameters have been applied, the two monocular ADAS cameras 104a and 104b may output rectilinear left and right images, respectively, where the respective optical axes are now parallel and each pixel that appears in the left image has a matching pixel in the right image. In an example, the pixel alignment of the left and right images may within one pixel or better (e.g., sub-pixel).

In an example, the processor/SoC 106 may be configured to store ground truth data in the memory 108. In an example, the ground truth data may comprise dual-channel encoded video images and disparity maps that are time-synchronized (e.g., using timestamps, etc.). In another example, the ground truth data may further comprise inertial data to enable calculation of a roll/pitch/yaw angle between adjacent frames, determination of whether the road is flat or sloped, and calculation of angle information. The inertial data may also include timestamp information to allow matching with the images and disparity maps. In an example, the ground truth acquisition device 100 may be configured to independently generate stereo disparity by running a stereo matching algorithm. In another example, the ground truth acquisition device 100 may be configured to generate disparity data by storing data to the memory 108 and exporting the data to run the stereo matching algorithm(s) in a remote system (e.g., offline). In an example, a point cloud may be calculated based on intrinsic parameters of the two monocular ADAS cameras 104a and 104b.

In some embodiments, the ground truth acquisition device 100 may further comprise an inertial measurement unit (IMU) 110 and/or a global navigation satellite system/global positioning system (GNSS/GPS) unit 112. In an example, the processor/SoC 106 may be configured to collect IMU data from the IMU 110. In an example, the processor/SoC 106 may be configured to collect accurate time information via a wireless connection (e.g., using a network time protocol (NTP)). In another example, the processor/SoC 106 may be configured to collect accurate time information from the GNSS/GPS unit 112. In another example, the processor/SoC 106 may be configured to determine accurate position information using the IMU data from the IMU 110 and an electronic map. In another example, the processor/SoC 106 may be configured to collect accurate position information from the GNSS/GPS unit 112. In an example, the IMU and GNSS/GPS data with timestamps may be utilized for post-processing in scene reconstruction.

In various embodiments, the processor/SoC 106 is generally configured to output a frame synchronization signal (e.g., FSYNC) to the two monocular ADAS cameras 104a and 104b. The frame synchronization signal FSYNC generally ensures the two monocular ADAS cameras 104a and 104b synchronize CMOS sensor exposure timing of every frame. In an example, the processor/SoC 106 may be configured to generate the frame synchronization signal FSYNC based on a real-time clock signal. In an example, the real-time clock signal may be generated internally by a real-time clock module of the processor/SoC 106. In another example, the real-time clock signal may be obtained from an external source (e.g., using a network time protocol (NTP), using accurate time information collected from the GNSS/GPS unit 112, etc.). The processor/SoC 106 is generally further configured to communicate control and video signals with the two monocular ADAS cameras 104a and 104b.

In various embodiments, the ground truth acquisition device 100 may be mounted in a housing 114. The housing 114 is generally configured to enclose the chassis structure (or camera mount) 102, the two monocular ADAS cameras 104a and 104b, the processor (or system-on-chip (SoC)) 106, and the memory 108. In embodiments implementing the IMU 110 and the GNSS/GPS unit 112, the IMU 110 and the GNSS/GPS unit 112 may also be enclosed within the housing 114. In an example, the housing 114 may be configured to mount the ground truth acquisition device 100 to the inside surface of the windshield 70 of the vehicle 50. In general, the ground truth acquisition device 100 is mounted at, or close to, the center of a width of the vehicle 50. In another example, the housing 114 may be configured to mount the ground truth acquisition device 100 to an exterior surface of the vehicle 50.

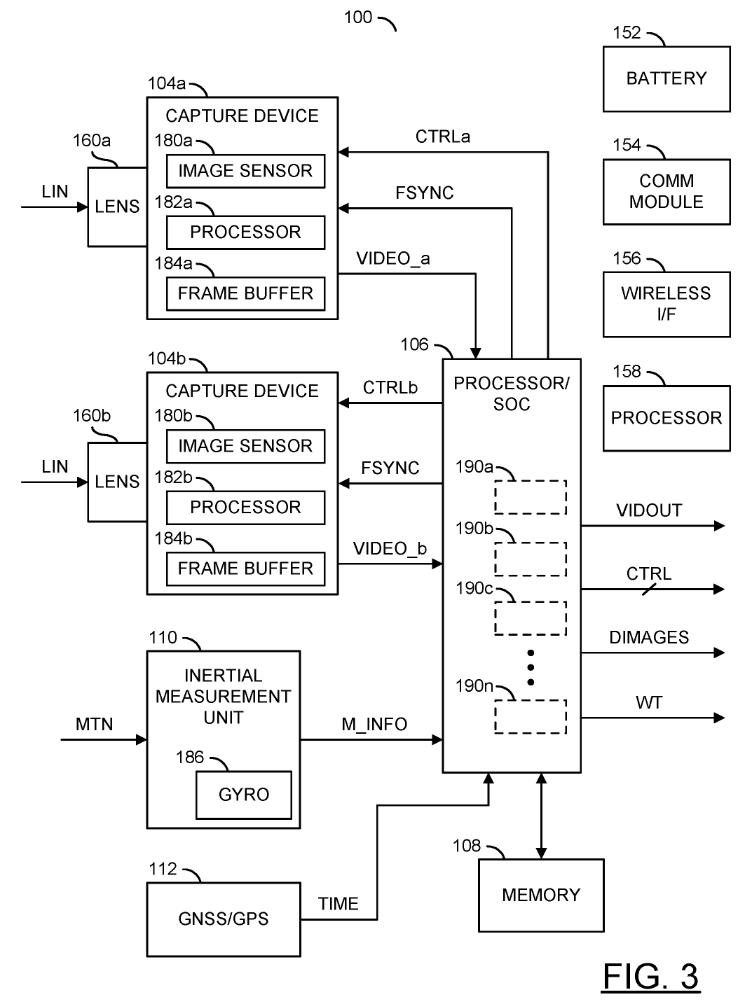

Referring to FIG. 3, a block diagram is shown illustrating an example implementation of a ground truth acquisition device in accordance with an example embodiment of the invention. In an example, the ground truth acquisition device 100 may comprise the camera (or capture device) 104a, the camera (or capture device) 104b, the processor/SoC 106, the memory 108, the IMU 110, and the GNSS/GPS module 112. In an example, the processor/SoC 106 may be implemented as a separate device from the IMU 110. In another example, the processor/SoC 106 and the IMU 110 may be combined in a single integrated device. In an example, the GNSS/GPS module 112 may be implemented using a pre-certified module.

In various embodiments, the ground truth acquisition device 100 may further comprise a block (or circuit) 152, a block (or circuit) 154, a block (or circuit) 156, a block (or circuit) 158, a block (or circuit) 160a, and/or a block (or circuit) 160b. The circuit 152 may implement a battery. The circuit 154 may implement a communication device (or module). The circuit 156 may implement a wireless interface. The circuit 158 may implement a general purpose processor. The blocks 160a and 160b may implement optical lenses. In some embodiments, the ground truth acquisition device 100 may comprise the processor/SoC 106, the capture devices 104a and 104b, the memory 108, the IMU 110, the lenses 160a and 160b, the battery 152, the communication module 154, the wireless interface 156, and the processor 158. In another example, the ground truth acquisition device 100 may comprise the processor/SoC 106, the capture device 104a, the capture device 104b, the IMU 110, the processor 158, the lens 160a, and the lens 160b as one device, and the memory 108, the battery 152, the communication module 154, and the wireless interface 156 may be components of a separate device. The ground truth acquisition device 100 may comprise other components (not shown). The number, type and/or arrangement of the components of the ground truth acquisition device 100 may be varied according to the design criteria of a particular implementation.

In some embodiments, the processor/SoC 106 may be implemented as a video processor. In an example, the processor/SoC 106 may be configured to receive multiple-sensor video input with high-speed SLVS/MIPI-CSI/LVCMOS interfaces. In some embodiments, the processor/SoC 106 may be configured to perform depth sensing in addition to generating video frames. In an example, the depth sensing may be performed in response to depth information captured in the video frames. In some embodiments, the processor/SoC 106 may be implemented as a dataflow vector processor. In an example, the processor/SoC 106 may comprise a highly parallel architecture configured to perform image/video processing.

The memory 108 may store data. The memory 108 may implement various types of memory including, but not limited to, a cache, flash memory, memory card, random access memory (RAM), dynamic RAM (DRAM) memory, etc. The type and/or size of the memory 108 may be varied according to the design criteria of a particular implementation. The data stored in the memory 108 may correspond to video information (e.g., frames, files, etc.), disparity and/or depth information, motion information (e.g., readings from the IMU 110), position information (e.g., data from the GNSS/GPS 112), time information (e.g., timestamps, data from the GNSS/GPS 112, etc.), video fusion parameters, image stabilization parameters, user inputs, computer vision models, feature sets, and/or metadata information. In various embodiments, the ground truth data generated by the ground truth acquisition device 100 may be stored in the memory 108. In some embodiments, the memory 108 may store the ground truth data comprising video image data, disparity data, depth map data, position data, motion data, timestamp data, etc. The video image data, disparity data, depth map data, position data, motion data, timestamp data, etc. may be used for computer vision operations, 3D reconstruction, scene reconstruction, auto-exposure, etc.

The processor/SoC 106 may be configured to execute computer readable code and/or process information. In various embodiments, the computer readable code may be stored within the processor/SoC 106 (e.g., microcode, etc.) and/or in the memory 108. In an example, the processor/SoC 106 may be configured to execute one or more artificial neural network models (e.g., facial recognition CNN, object detection CNN, object classification CNN, 3D reconstruction CNN, liveness detection CNN, etc.) stored in the memory 108. In an example, the memory 108 may store one or more directed acyclic graphs (DAGs) and one or more sets of weights and biases defining the one or more artificial neural network models. In yet another example, the memory 108 may store instructions to perform transformational operations (e.g., Discrete Cosine Transform, Discrete Fourier Transform, Fast Fourier Transform, etc.). The processor/SoC 106 may be configured to receive input from and/or present output to the memory 108. The processor/SoC 106 may be configured to store the ground truth data generated by the ground truth acquisition device 100 in the memory 108. The processor/SoC 106 may be configured to present and/or receive other signals (not shown). The number and/or types of inputs and/or outputs of the processor/SoC 106 may be varied according to the design criteria of a particular implementation. The processor/SoC 106 may be configured for low power (e.g., battery) operation.

The battery 152 may be configured to store and/or supply power for the components of the ground truth acquisition device 100. In some embodiments, the ground truth acquisition device 100 may include a dynamic driver mechanism for a rolling shutter sensor that may be configured to conserve power consumption. Reducing the power consumption may enable the ground truth acquisition device 100 to operate using the battery 152 for extended periods of time without recharging. The battery 152 may be rechargeable. The battery 152 may be built-in (e.g., non-replaceable) or replaceable. The battery 152 may have an input for connection to an external power source (e.g., for charging). In some embodiments, the ground truth acquisition device 100 may be powered by an external power supply (e.g., the battery 152 may not be implemented or may be implemented as a back-up power supply). The battery 152 may be implemented using various battery technologies and/or chemistries. The type of the battery 152 implemented may be varied according to the design criteria of a particular implementation.

The communications module 154 may be configured to implement one or more communications protocols. For example, the communications module 154 and the wireless interface 156 may be configured to implement one or more of, IEEE 102.11, IEEE 102.15, IEEE 102.15.1, IEEE 102.15.2, IEEE 102.15.3, IEEE 102.15.4, IEEE 102.15.5, IEEE 102.20, Bluetooth®, and/or ZigBee®. In some embodiments, the communication module 154 may be a hard-wired data port (e.g., a USB port, a mini-USB port, a USB-C connector, HDMI port, an Ethernet port, a DisplayPort interface, a Lightning port, etc.). In some embodiments, the wireless interface 156 may also implement one or more protocols (e.g., GSM, CDMA, GPRS, UMTS, CDMA2000, 3GPP LTE, 4G/HSPA/WiMAX, SMS, etc.) associated with cellular communication networks. In embodiments where the ground truth acquisition device 100 is implemented as a wireless camera, the protocol implemented by the communications module 154 and wireless interface 156 may be a wireless communications protocol. The type of communications protocols implemented by the communications module 154 may be varied according to the design criteria of a particular implementation.

The communications module 154 and/or the wireless interface 156 may be configured to generate a broadcast signal as an output from the ground truth acquisition device 100. The broadcast signal may send video data, disparity data, ground truth data, and/or control signal(s) to external devices. For example, the broadcast signal may be sent to a cloud storage service (e.g., a storage service capable of scaling on demand). In some embodiments, the communications module 154 may not transmit data until the processor/SoC 106 has performed video analytics to determine that an object is in the field of view of the ground truth acquisition device 100.

In some embodiments, the communications module 154 may be configured to generate a manual control signal. The manual control signal may be generated in response to a signal from a user received by the communications module 154. The manual control signal may be configured to activate the processor/SoC 106. The processor/SoC 106 may be activated in response to the manual control signal regardless of the power state of the ground truth acquisition device 100.

In some embodiments, the communications module 154 and/or the wireless interface 156 may be configured to receive a feature set. The feature set received may be used to detect events and/or objects. For example, the feature set may be used to perform the computer vision operations. The feature set information may comprise instructions for the processor/SoC 106 for determining which types of objects correspond to an object and/or event of interest.

In some embodiments, the communications module 154 and/or the wireless interface 156 may be configured to receive user input. The user input may enable a user to adjust operating parameters for various features implemented by the processor/SoC 106. In some embodiments, the communications module 154 and/or the wireless interface 156 may be configured to interface (e.g., using an application programming interface (API) with an application (e.g., an app). For example, the app may be implemented on a smartphone to enable an end user to adjust various settings and/or parameters for the various features implemented by the processor/SoC 106 (e.g., set video resolution, select frame rate, select output format, set tolerance parameters for 3D reconstruction, etc.).

The processor 158 may be implemented using a general purpose processor circuit. The processor 158 may be operational to interact with the processor/SoC 106 and the memory 108 to perform various processing tasks. The processor 158 may be configured to execute computer readable instructions. In one example, the computer readable instructions may be stored by the memory 108. In some embodiments, the processor 158 may send data to and/or receive data from other components of the ground truth acquisition device 100 (e.g., the battery 152, the communication module 154 and/or the wireless interface 156). In some embodiments, the processor 158 may implement an integrated digital signal processor (IDSP). For example, the IDSP 158 may be configured to implement a warp engine. Which of the functionality of the ground truth acquisition device 100 is performed by the processor/SoC 106 and the general purpose processor 158 may be varied according to the design criteria of a particular implementation.

The lenses 160a and 160b may be attached to the capture devices 104a and 104b, respectively. The capture devices 104a and 104b may be configured to receive an input signal (e.g., LIN) via the lenses 160a and 160b. The signal LIN may be a light input (e.g., an analog image). The lenses 160a and 160b may be implemented as an optical lenses. The lenses 160a and 160b may provide a zooming feature and/or a focusing feature. The capture device 104a and/or the lens 160a may be implemented, in one example, as a single lens assembly. In another example, the lens 160a may be a separate implementation from the capture device 104a. The capture device 104b and/or the lens 160b may be implemented, in one example, as a single lens assembly. In another example, the lens 160b may be a separate implementation from the capture device 104b.

The capture devices 104a and 104b may be configured to convert the input light LIN into computer readable data. The capture devices 104a and 104b may capture data received through the lenses 160a and 160b to generate raw pixel data. In some embodiments, the capture devices 104a and 104b may capture data received through the lenses 160a and 160b to generate bitstreams. In an example, the bitstreams may comprise pixel data arranged as video frames. For example, the capture devices 104a and 104b may receive focused light from the lenses 160a and 160b. The lenses 160a and 160b may be directed, tilted, panned, zoomed and/or rotated to provide a targeted view from the ground truth acquisition device 100 (e.g., a view for a video image, etc.). The capture device 104a may generate a signal (e.g., VIDEO_a). The capture device 104 may generate a signal (e.g., VIDEO_b). The signals VIDEO_a and VIDEO_b may comprise pixel data (e.g., a sequence of pixels that may be used to generate video frames). In some embodiments, the signals VIDEO_a and VIDEO_b may comprise video data (e.g., a sequence of video frames). The signals VIDEO_a and VIDEO_b may be presented to one or more of the inputs of the processor/SoC 106. In some embodiments, the pixel data generated by the capture devices 104a and 104b may be uncompressed and/or raw data generated in response to the focused light from the lenses 160a and 160b. In some embodiments, the output of the capture devices 104a and 104b may be digital video signals.

In an example, the capture device 104a may comprise a block (or circuit) 180a, a block (or circuit) 182a, and a block (or circuit) 184a, and the capture device 104b may comprise a block (or circuit) 180b, a block (or circuit) 182b, and a block (or circuit) 184b. The circuits 180a and 180b may be image sensors. The circuits 182a and 182b may be a processor and/or logic. The circuits 184a and 184b may be a memory circuit (e.g., a frame buffer). The lenses 160a and 160b (e.g., camera lenses) may be directed to provide a view of an external environment of the ground truth acquisition device 100. The lenses 160a and 160b may be aimed to capture environmental data (e.g., the light input LIN). The lenses 160a and 160b may be a wide-angle lens and/or a fish-eye lens (e.g., lenses capable of capturing a wide field of view). The lenses 160a and 160b may be configured to capture and/or focus the light for the capture devices 104a and 104b. Generally, the image sensors 180a and 180b are located behind the lenses 160a and 160b. Based on the captured light from the lenses 160a and 160b, the capture devices 104a and 104b may generate a bitstream and/or video data (e.g., the signals VIDEO_a and VIDEO_b).

The capture devices 104a and 104b may be configured to capture video image data (e.g., light collected and focused by the lenses 160a and 160b). The capture devices 104a and 104b may capture data received through the lenses 160a and 160b to generate a video bitstream (e.g., pixel data for a sequence of video frames). In various embodiments, the lenses 160a and 160b may be implemented as a fixed focus lenses. A fixed focus lens generally facilitates smaller size and low power. In an example, a fixed focus lens may be used in battery powered and other low power camera applications. In some embodiments, the lenses 160a and 160b may be directed, tilted, panned, zoomed and/or rotated to capture the environment surrounding the ground truth acquisition device 100 (e.g., capture data from the field of view). In an example, professional camera models may be implemented with an active lens system for enhanced functionality, remote control, etc.

The capture devices 104a and 104b may transform the received light into a digital data stream. In some embodiments, the capture devices 104a and 104b may perform an analog to digital conversion. For example, the image sensors 180a and 180b may perform a photoelectric conversion of the light received by the lenses 160a and 160b. The processor/logic circuits 182a and 182b may transform the digital data stream into a video data stream (or bitstream), a video file, and/or a number of video frames. In an example, the capture devices 104a and 104b may present the video data as a digital video signal (e.g., the signals VIDEO_a and VIDEO_b). The digital video signals may comprise the video frames (e.g., sequential digital images and/or audio). In some embodiments, the capture devices 104a and 104b may comprise a microphone for capturing audio.

The video data captured by the capture devices 104a and 104b may be represented as signals/bitstreams/data VIDEO_a and VIDEO_b (e.g., digital video signals). The capture devices 104a and 104b may present the signals VIDEO_a and VIDEO_b to the processor/SoC 106. The signals VIDEO_a and VIDEO_b may represent the video frames/video data. The signals VIDEO_a and VIDEO_b may be video streams captured by the capture devices 104a and 104b. In some embodiments, the signals VIDEO_a and VIDEO_b may comprise pixel data that may be operated on by the processor/SoC 106 (e.g., in a video processing pipeline, an image signal processor (ISP), etc.). The processor/SoC 106 may generate video frames in response to the pixel data in the signals VIDEO_a and VIDEO_b.

The signals VIDEO_a and VIDEO_b may comprise pixel data arranged as video frames. In some embodiments, the signals VIDEO_a and VIDEO_b may be images comprising a background (e.g., objects and/or the environment captured) and the speckle pattern generated by a structured light projector. The signals VIDEO_a and VIDEO_b may comprise single-channel source images. The single-channel source images may be generated in response to capturing the pixel data using the monocular lenses 160a and 160b.

The image sensors 180a and 180b may receive the input light LIN from the lenses 160a and 160b. The image sensors 180a and 180b may transform the light LIN into digital data (e.g., the bitstreams). For example, the image sensors 180a and 180b may perform a photoelectric conversion of the light from the lenses 160a and 160b. In an example, the sensors 180a and 180b may complimentary metal oxide semiconductor (CMOS) sensors. In some embodiments, the image sensors 180a and 180b may have extra margins that are not used as part of the image output. In some embodiments, the image sensors 180a and 180b may not have extra margins. In various embodiments, the image sensors 180a and 180b may be implemented as an RGB sensor, an RGB-IR sensor, an RGGB sensor, a monochrome image sensor, a thermal sensor, an event-based sensor, etc. However, other color pattern sensors may be implemented accordingly. For example, the image sensors 180a and 180b may be any type of sensor configured to provide sufficient output for computer vision operations to be performed on the output data (e.g., neural network-based detection, etc.). In an example, the image sensors 180a and 180b may be configured to generate an RGB-IR video signal. In an infrared light only illuminated field of view, the image sensors 180a and 180b may generate a monochrome (B/W) video signal. In a field of view illuminated by both IR light and visible light, the image sensors 180a and 180b may be configured to generate color information in addition to the monochrome video signal. In various embodiments, the image sensors 180a and 180b may be configured to generate a video signal in response to visible and/or infrared (IR) light.

In various embodiments, the camera sensors 180a and 180b may comprise a rolling shutter sensor or a global shutter sensor. In various embodiments, a pair of matched (e.g., identical) monocular ADAS cameras is mounted on the chassis structure 102 for enabling stereo matching. In an example, rolling shutter sensors do not create a problem when used for stereo vision, because even if there are rolling shutter artifacts caused by motion, the effect is similar in vertical direction for left and right cameras, when the shutter timing is synchronized for left and right cameras.

In an example, the rolling shutter sensors 180a and 180b may implement RGB-IR sensors. In an example, the rolling shutter sensors 180a and 180b may be implemented as an RGB-IR rolling shutter complementary metal oxide semiconductor (CMOS) image sensor. In some embodiments, the sensors 180a and 180b of the capture devices 104a and 104b may be implemented as separate components. In an example, the capture devices 104a and 104b may comprise a rolling shutter IR sensor and an RGB sensor.

In one example, the rolling shutter sensors 180a and 180b may be configured to assert a signal that indicates a first line exposure time. In one example, the rolling shutter sensors 180a and 180b may apply a mask to a monochrome sensor. In an example, the mask may comprise a plurality of units containing one red pixel, one green pixel, one blue pixel, and one IR pixel. The IR pixel may contain red, green, and blue filter materials that effectively absorb all of the light in the visible spectrum, while allowing the longer infrared wavelengths to pass through with minimal loss. With a rolling shutter, as each line (or row) of the sensor starts exposure, all pixels in the line (or row) may start exposure simultaneously.

The processor/logic circuits 182a and 182b may transform the bitstream into a human viewable content (e.g., video data that may be understandable to an average person regardless of image quality, such as the video frames and/or pixel data that may be converted into video frames by the processor/SoC 106). For example, the processor/logic circuits 182a and 182b may receive pure (e.g., raw) data from the image sensors 180a and 180b and generate (e.g., encode) video data (e.g., the bitstream) based on the raw data. The capture devices 104a and 104b may have the memories 184a and 184b to store the raw data and/or the processed bitstream. For example, the capture devices 104a and 104b may implement the frame memories and/or buffers 184a and 184b to store (e.g., provide temporary storage and/or cache) one or more of the video frames (e.g., the digital video signal).

In some embodiments, the processor/logic circuits 182a and 182b may perform analysis and/or correction on the video frames stored in the memories/buffers 184a and 184b of the capture devices 104a and 104b. In an example, the processor/logic circuits 182a and 182b may implement an image digital signal processing pipeline. In an example, the processor/logic circuits 182a and 182b may apply warp parameters received from the processor/SoC 106 to the video frames stored in the memories/buffers 184a and 184b of the capture devices 104a and 104b. After the processor/logic circuits 182a and 182b have applied the warp parameters to the video frames stored in the memories/buffers 184a and 184b of the capture devices 104a and 104b, the processor/logic circuits 182a and 182b may communicated the warped video frames to the processor/SoC 106 (e.g., via the signals VIDEO_a and VIDEO_b). The processor/logic circuits 182a and 182b may provide status information about the captured video frames.

The IMU 110 may be configured to detect motion and/or movement of the ground truth acquisition device 100. The IMU 110 is shown receiving a signal (e.g., MTN). The signal MTN may comprise a combination of forces acting on the camera system 100. The signal MTN may comprise movement, vibrations, shakiness, a panning direction, jerkiness, etc. The signal MTN may represent movement (e.g., pitch/yaw/roll) in three dimensional space (e.g., movement in an X direction, a Y direction and a Z direction). In an example, the IMU 110 may be synchronized by the processor/SoC 106 with the capture devices 104a and 104b. In an example, the sensor data captured by the images sensors 180a and 180b and the IMU data captured by the IMU 110 may each have accurate timestamps that allows subsequent matching of the data. In an example, the IMU 110 and the capture devices 104a and 104b are tightly coupled by their mounting in the ground truth acquisition device 100. The tightly coupling the IMU 110 and the capture devices 104a and 104b generally allows the IMU 110 to assist in calculating rotation angles around the X/Y/Z axes and to help in scene reconstruction (e.g., using a Simultaneous Localization and Mapping (SLAM) algorithm). In an example, the IMU data may also help in determining road information (e.g.,whether the road is flat or sloped, and angle information). The type and/or amount of motion received (detected) by the IMU 110 may be varied according to the design criteria of a particular implementation.

In an example, the IMU 110 may comprise a block (or circuit) 186. The circuit 186 may implement a motion sensor. In an example, the motion sensor 186 may comprise an accelerometer. In one example, the motion sensor 186 may comprise a gyroscope. The gyroscope 186 may be configured to measure the amount of movement. For example, the gyroscope 186 may be configured to detect an amount and/or direction of the movement of the ground truth acquisition device 100 (e.g., the signal MTN) and convert the movement into electrical data. The IMU 110 may be configured to determine the amount of movement and/or the direction of movement measured by the gyroscope 186. The IMU 110 may convert the electrical data from the gyroscope 186 into a format readable by the processor/SoC 106. The IMU 110 may be configured to generate a signal (e.g., M_INFO). The signal M_INFO may comprise the measurement information in the format readable by the processor/SoC 106. The IMU 110 may present the signal M_INFO to the processor/SoC 106. The number, type and/or arrangement of the components of the IMU 110 and/or the number, type and/or functionality of the signals communicated by the IMU 110 may be varied according to the design criteria of a particular implementation.

The GNSS/GPS module 112 may be configured to generate accurate time, motion, and/or position information. In an example, the GNSS/GPS module 112 may generate a signal (e.g., TIME) that provides accurate time information. The time information provided by the signal TIME may be used by the processor/SoC 106 to generate timestamps for the data communicated by the signals VIDEO_a, VIDEO_b, and M_INFO. In some embodiments, the GNSS/GPS module 112 may provide data that enriches the data captured by the IMU 110 and the capture devices 104a and 104b, making the captured data more useful when used to create a high-definition (HD) map. The accurate geographical information and accurate time provided by the GNSS/GPS module 112 may be useful in post processing scene reconstruction. In an example, scene reconstruction may include, but is not limited to, calculating building height and size, road width, vehicle distances and speed on the road, the topology of the road, the traffic signs and traffic lights of the road, etc. In an example, the GNSS/GPS module 112 may include, but is not limited to, standard GPS, differential GPS (dGPS), and GNSS with real time kinematics (RTK) corrections.

The processor/SoC 106 may receive the signals VIDEO_a and VIDEO_b, the signal M_INFO, and the signal TIME. The processor/SoC 106 may generate the frame synchronization signal FSYNC, one or more video output signals (e.g., VIDOUT), one or more control signals (e.g., CTRLa, CTRLb, CTRL, etc.), one or more depth data signals (e.g., DIMAGES), and/or one or more warp table data signals (e.g., WT) based on the signals VIDEO_a and VIDEO_b, the signal M_INFO, the signal TIME, and/or other input. In some embodiments, the signals VIDOUT, DIMAGES, WT, and CTRL may be generated based on analysis of the signals VIDEO_a and VIDEO_b and/or objects detected in the signals VIDEO_a and VIDEO_b. In some embodiments, the signals VIDOUT, DIMAGES, WT, and CTRL may be generated based on analysis of the signals VIDEO_a and VIDEO_b, the movement information captured by the IMU 110, and/or the intrinsic properties of the lenses 160a and 160b, and/or the capture devices 104a and 140b. In various embodiments, the processor/SoC 106 communicates the frame synchronization signal FSYNC and the warp table data signals to the capture devices 104a and 104b to enable the capture devices 104a and 104b to align the respective video images contained in the signals VIDEO_a and VIDEO_b.

In various embodiments, the processor/SoC 106 may be configured to perform one or more of feature extraction, object detection, object tracking, electronic image stabilization, 3D reconstruction, liveness detection and object identification. For example, the processor/SoC 106 may determine motion information and/or depth information by analyzing and comparing frames from the signals VIDEO_a and VIDEO_b. The comparison may be used to perform digital motion estimation. In some embodiments, the processor/SoC 106 may be configured to generate the video output signal VIDOUT comprising video data, the warp table data signal WT, and/or the depth data signal DIMAGES comprising disparity maps and depth maps from the signals VIDEO_a and VIDEO_b. The video output signal VIDOUT, the warp table data signal WT, and/or the depth data signal DIMAGES may be presented to the memory 108, the communications module 154, and/or the wireless interface 156. In some embodiments, the video signal VIDOUT, the warp table data signal WT, and/or the depth data signal DIMAGES may be used internally by the processor/SoC 106 (e.g., not presented as output). In one example, the warp table data signal WT may be used by a warp engine implemented by a digital signal processor (e.g., the processor the processor/logic circuit 182a and 182b) in the capture devices 104a and 104b.

The signal VIDOUT may be presented to the communication device 156. In some embodiments, the signal VIDOUT may comprise encoded video frames generated by the processor/SoC 106. In some embodiments, the encoded video frames may comprise a full video stream (e.g., encoded video frames representing all video captured by the capture devices 104a and 104b). The encoded video frames may be encoded, cropped, stitched, stabilized and/or enhanced versions of the pixel data received from the signals VIDEO_a and VIDEO_b. In an example, the encoded video frames may be a high resolution, digital, encoded, de-warped, stabilized, cropped, blended, stitched and/or rolling shutter effect corrected version of the signals VIDEO_a and VIDEO_b.

In some embodiments, the signal VIDOUT may be generated based on video analytics (e.g., computer vision operations) performed by the processor/SoC 106 on the video frames generated. The processor/SoC 106 may be configured to perform the computer vision operations to detect objects and/or events in the video frames and then convert the detected objects and/or events into statistics and/or parameters. In one example, the data determined by the computer vision operations may be converted to the human-readable format by the processor/SoC 106. The data from the computer vision operations may be used to detect objects and/or events. The computer vision operations may be performed by the processor/SoC 106 locally (e.g., without communicating to an external device to offload computing operations). Similarly other video processing and/or encoding operations (e.g., stabilization, compression, stitching, cropping, rolling shutter effect correction, etc.) may be performed by the processor/SoC 106 locally. For example, the locally performed computer vision operations may enable the computer vision operations to be performed by the processor/SoC 106 and avoid heavy video processing running on back-end servers. Avoiding video processing running on back-end (e.g., remotely located) servers may preserve privacy.

In some embodiments, the signal VIDOUT may be data generated by the processor/SoC 106 (e.g., video analysis results, audio/speech analysis results, stabilized video frames, etc.) that may be communicated to a cloud computing service in order to aggregate information and/or provide training data for machine learning (e.g., to improve object detection, to improve audio detection, to improve liveness detection, etc.). In some embodiments, the signal VIDOUT may be provided to a cloud service for mass storage (e.g., to enable a user to retrieve the encoded video using a smartphone and/or a desktop computer). In some embodiments, the signal VIDOUT may comprise the data extracted from the video frames (e.g., the results of the computer vision), and the results may be communicated to another device (e.g., a remote server, a cloud computing system, etc.) to offload analysis of the results to another device (e.g., offload analysis of the results to a cloud computing service instead of performing all the analysis locally). The type of information communicated by the signal VIDOUT may be varied according to the design criteria of a particular implementation.

The signal CTRL may be configured to provide a control signal. The signal CTRL may be generated in response to decisions made by the processor/SoC 106. In one example, the signal CTRL may be generated in response to objects detected and/or characteristics extracted from the video frames. The signal CTRL may be configured to enable, disable, change a mode of operations of another device. In one example, a door controlled by an electronic lock may be locked/unlocked in response the signal CTRL. In another example, a device may be set to a sleep mode (e.g., a low-power mode) and/or activated from the sleep mode in response to the signal CTRL. In yet another example, an alarm and/or a notification may be generated in response to the signal CTRL. The type of device controlled by the signal CTRL, and/or a reaction performed by of the device in response to the signal CTRL may be varied according to the design criteria of a particular implementation.

The signal CTRL may be generated based on additional data received by the processor/SoC 106 (e.g., a temperature reading, a motion sensor reading, etc.). The signal CTRL may be generated based on input from a human interface device (HID). The signal CTRL may be generated based on behaviors of objects detected in the video frames by the processor/SoC 106. The signal CTRL may be generated based on a type of object detected (e.g., a person, an animal, a vehicle, etc.). The signal CTRL may be generated in response to particular types of objects being detected in particular locations. The signal CTRL may be generated in response to user input in order to provide various parameters and/or settings to the processor/SoC 106 and/or the memory 108. The processor/SoC 106 may be configured to generate the signal CTRL in response to sensor fusion operations (e.g., aggregating information received from disparate sources). The processor/SoC 106 may be configured to generate the signal CTRL in response to results of liveness detection performed by the processor/SoC 106. The conditions for generating the signal CTRL may be varied according to the design criteria of a particular implementation.

The signal DIMAGES may comprise one or more of depth maps and/or disparity maps generated by the processor/SoC 106. The signal DIMAGES may be generated in response to 3D reconstruction performed on the monocular single-channel images. The signal DIMAGES may be generated in response to analysis of the captured video data and/or a structured light pattern.

A multi-step approach to activating and/or disabling the capture devices 104a and 104b and/or any other power consuming features of the ground truth acquisition device 100 may be implemented to reduce a power consumption of the ground truth acquisition device 100 and extend an operational lifetime of the battery 152. In an example, a motion sensor may have a low drain on the battery 152 (e.g., less than 10 W). In an example, the motion sensor may be configured to remain on (e.g., always active) unless disabled in response to feedback from the processor/SoC 106. The video analytics performed by the processor/SoC 106 may have a relatively large drain on the battery 152 (e.g., greater than the IMU 110). In an example, the processor/SoC 106 may be in a low-power state (or power-down) until some motion is detected.

The ground truth acquisition device 100 may be configured to operate using various power states. For example, in the power-down state (e.g., a sleep state, a low-power state) the motion sensor of the sensors 164 and the processor/SoC 106 may be on and other components of the ground truth acquisition device 100 (e.g., the image capture devices 104a and 104b, the memory 108, the communications module 154, etc.) may be off. In another example, the ground truth acquisition device 100 may operate in an intermediate state. In the intermediate state, the image capture devices 104a and 104b may be on and the memory 108 and/or the communications module 154 may be off. In yet another example, the ground truth acquisition device 100 may operate in a power-on (or high power) state. In the power-on state, the processor/SoC 106, the capture devices 104a and 104b, the memory 108, and/or the communications module 154 may be on. The ground truth acquisition device 100 may consume some power from the battery 152 in the power-down state (e.g., a relatively small and/or minimal amount of power). The ground truth acquisition device 100 may consume more power from the battery 152 in the power-on state. The number of power states and/or the components of the ground truth acquisition device 100 that are on while the ground truth acquisition device 100 operates in each of the power states may be varied according to the design criteria of a particular implementation.

In some embodiments, the ground truth acquisition device 100 may be implemented as a system on chip (SoC). In some embodiments, the ground truth acquisition device 100 may be implemented as a printed circuit board comprising one or more components. The ground truth acquisition device 100 may be configured to perform intelligent video analysis on the video frames of the video. The ground truth acquisition device 100 may be configured to crop and/or enhance the video.

In some embodiments, the video frames may be some view (or derivative of some view) captured by the capture devices 104a and 104b. The pixel data signals may be enhanced by the processor/SoC 106 (e.g., color conversion, noise filtering, auto exposure, auto white balance, auto focus, etc.). In some embodiments, the video frames may provide a series of cropped and/or enhanced video frames that improve upon the view from the perspective of the ground truth acquisition device 100 (e.g., provides night vision, provides High Dynamic Range (HDR) imaging, provides more viewing area, highlights detected objects, provides additional data such as a numerical distance to detected objects, etc.) to enable the processor/SoC 106 to see the location better than a person would be capable of with human vision.

The encoded video frames may be processed locally. In one example, the encoded, video may be stored locally by the memory 108 to enable the processor/SoC 106 to facilitate the computer vision analysis internally (e.g., without first uploading video frames to a cloud service). The processor/SoC 106 may be configured to select the video frames to be packetized as a video stream that may be transmitted over a network (e.g., a bandwidth limited network).

In some embodiments, the processor/SoC 106 may be configured to perform sensor fusion operations. The sensor fusion operations performed by the processor/SoC 106 may be configured to analyze information from multiple sources (e.g., the capture device 104a, the capture device 104b, the IMU 110, and the GNSS/GPS module 112). By analyzing various data from disparate sources, the sensor fusion operations may be capable of making inferences about the data that may not be possible from one of the data sources alone. For example, the sensor fusion operations implemented by the processor/SoC 106 may analyze video data (e.g., mouth movements of people) as well as the speech patterns from directional audio. The disparate sources may be used to develop a model of a scenario to support decision making. For example, the processor/SoC 106 may be configured to compare the synchronization of the detected speech patterns with the mouth movements in the video frames to determine which person in a video frame is speaking. The sensor fusion operations may also provide time correlation, spatial correlation and/or reliability among the data being received.

In some embodiments, the processor/SoC 106 may implement convolutional neural network capabilities. The convolutional neural network capabilities may implement computer vision using deep learning techniques. The convolutional neural network capabilities may be configured to implement pattern and/or image recognition using a training process through multiple layers of feature-detection. The computer vision and/or convolutional neural network capabilities may be performed locally by the processor/SoC 106. In some embodiments, the processor/SoC 106 may receive training data and/or feature set information from an external source. For example, an external device (e.g., a cloud service) may have access to various sources of data to use as training data that may be unavailable to the ground truth acquisition device 100. However, the computer vision operations performed using the feature set may be performed using the computational resources of the processor/SoC 106 within the ground truth acquisition device 100.

A video pipeline of the processor/SoC 106 may be configured to locally perform de-warping, cropping, enhancements, rolling shutter corrections, stabilizing, downscaling, packetizing, compression, conversion, blending, synchronizing and/or other video operations. The video pipeline of the processor/SoC 106 may enable multi-stream support (e.g., generate multiple bitstreams in parallel, each comprising a different bitrate). In an example, the video pipeline of the processor/SoC 106 may implement an image signal processor (ISP) with a 320 MPixels/s input pixel rate. The architecture of the video pipeline of the processor/SoC 106 may enable the video operations to be performed on high resolution video and/or high bitrate video data in real-time and/or near real-time. The video pipeline of the processor/SoC 106 may enable computer vision processing on 4K resolution video data, stereo vision processing, object detection, 3D noise reduction, fisheye lens correction (e.g., real time 360-degree dewarping and lens distortion correction), oversampling and/or high dynamic range processing. In one example, the architecture of the video pipeline may enable 4K ultra high resolution with H.264 encoding at double real time speed (e.g., 60fps), 4K ultra high resolution with H.265/HEVC at 30fps and/or 4K AVC encoding (e.g., 4KP30 AVC and HEVC encoding with multi-stream support). The type of video operations and/or the type of video data operated on by the processor/SoC 106 may be varied according to the design criteria of a particular implementation.

The camera sensors 180a and 180b may implement a high-resolution sensor. Using the high resolution sensors 180a and 180b, the processor/SoC 106 may combine over-sampling of the image sensors 180a and 180b with digital zooming within a cropped area. The over-sampling and digital zooming may each be one of the video operations performed by the processor/SoC 106. The over-sampling and digital zooming may be implemented to deliver higher resolution images within the total size constraints of a cropped area.

In some embodiments, the lenses 160a and 160b may implement a fisheye lens. One of the video operations implemented by the processor/SoC 106 may be a dewarping operation. The processor/SoC 106 may be configured to dewarp the video frames generated. The dewarping may be configured to reduce and/or remove acute distortion caused by the fisheye lens and/or other lens characteristics. For example, the dewarping may reduce and/or eliminate a bulging effect to provide a rectilinear image.

The processor/SoC 106 may be configured to crop (e.g., trim to) a region of interest from a full video frame (e.g., generate the region of interest video frames). The processor/SoC 106 may generate the video frames and select an area. In an example, cropping the region of interest may generate a second image. The cropped image (e.g., the region of interest video frame) may be smaller than the original video frame (e.g., the cropped image may be a portion of the captured video).

The area of interest may be dynamically adjusted based on the location of an audio source. For example, the detected audio source may be moving, and the location of the detected audio source may move as the video frames are captured. The processor/SoC 106 may update the selected region of interest coordinates and dynamically update the cropped section. The cropped section may correspond to the area of interest selected. As the area of interest changes, the cropped portion may change. For example, the selected coordinates for the area of interest may change from frame to frame, and the processor/SoC 106 may be configured to crop the selected region in each frame.

The processor/SoC 106 may be configured to over-sample the image sensors 180a and 180b. The over-sampling of the image sensors 180a and 180b may result in a higher resolution image. The processor/SoC 106 may be configured to digitally zoom into an area of a video frame. For example, the processor/SoC 106 may digitally zoom into the cropped area of interest. For example, the processor/SoC 106 may establish the area of interest based on the directional audio, crop the area of interest, and then digitally zoom into the cropped region of interest video frame.

The dewarping operations performed by the processor/SoC 106 may adjust the visual content of the video data. The adjustments performed by the processor/SoC 106 may cause the visual content to appear natural (e.g., appear as seen by a person viewing the location corresponding to the field of view of the capture devices 104a and 104b). In an example, the dewarping may alter the video data to generate a rectilinear video frame (e.g., correct artifacts caused by the lens characteristics of the lenses 160a and 160b). The dewarping operations may be implemented to correct the distortion caused by the lenses 160a and 160b. The adjusted visual content may be generated to enable more accurate and/or reliable object detection.

Various features (e.g., dewarping, digitally zooming, cropping, etc.) may be implemented in the processor/SoC 106 as hardware modules. Implementing hardware modules may increase the video processing speed of the processor/SoC 106 (e.g., faster than a software implementation). The hardware implementation may enable the video to be processed while reducing an amount of delay. The hardware components used may be varied according to the design criteria of a particular implementation.

In some embodiments, the processor/SoC 106 may implement one or more coprocessors, cores and/or chiplets. For example, the processor/SoC 106 may implement one coprocessor configured as a general purpose processor and another coprocessor configured as a video processor. In some embodiments, the processor/SoC 106 may be a dedicated hardware module designed to perform particular tasks. In an example, the processor/SoC 106 may implement an AI accelerator. In another example, the processor/SoC 106 may implement a radar processor. In yet another example, the processor/SoC 106 may implement a dataflow vector processor. In some embodiments, other processors implemented by the ground truth acquisition device 100 may be generic processors and/or video processors (e.g., a coprocessor that is physically a different chipset and/or silicon from the processor/SoC 106). In one example, the processor/SoC 106 may implement an x86-64 instruction set. In another example, the processor/SoC 106 may implement an ARM instruction set. In yet another example, the processor/SoC 106 may implement a RISC-V instruction set. The number of cores, coprocessors, the design optimization and/or the instruction set implemented by the processor/SoC 106 may be varied according to the design criteria of a particular implementation.

The processor/SoC 106 is shown comprising a number of blocks (or circuits) 190a-190n. The blocks 190a-190n may implement various hardware modules implemented by the processor/SoC 106. The hardware modules 190a-190n may be configured to provide various hardware components to implement a video processing pipeline, a radar signal processing pipeline, and/or an AI processing pipeline. The circuits 190a-190n may be configured to receive the pixel data from the signals VIDEO_a and VIDEO_b, generate the video frames from the pixel data, perform various operations on the video frames (e.g., de-warping, rolling shutter correction, cropping, upscaling, image stabilization, 3D reconstruction, liveness detection, auto-exposure, etc.), prepare the video frames for communication to external hardware (e.g., encoding, packetizing, color correcting, etc.), parse feature sets, implement various operations for computer vision (e.g., object detection, segmentation, classification, etc.), etc. The hardware modules 190a-190n may be configured to implement various security features (e.g., secure boot, I/O virtualization, etc.). Various implementations of the processor/SoC 106 may not necessarily utilize all the features of the hardware modules 190a-190n. The features and/or functionality of the hardware modules 190a-190n may be varied according to the design criteria of a particular implementation. Details of the hardware modules 190a-190n may be described in association with U.S. Patent Application No. 16/831,549, filed on April 16, 2020, U.S. Patent Application No. 16/288,922, filed on February 28, 2019, U.S. Patent Application No. 15/593,493 (now U.S. Patent No. 10,437,600), filed on May 12, 2017, U.S. Patent Application No. 15/931,942, filed on May 14, 2020, U.S. Patent Application No. 16/991,344, filed on August 12, 2020, U.S. Patent Application No. 17/479,034, filed on September 20, 2021, appropriate portions of which are hereby incorporated by reference in their entirety.

The hardware modules 190a-190n may be implemented as dedicated hardware modules. Implementing various functionality of the processor/SoC 106 using the dedicated hardware modules 190a-190n may enable the processor/SoC 106 to be highly optimized and/or customized to limit power consumption, reduce heat generation and/or increase processing speed compared to software implementations. The hardware modules 190a-190n may be customizable and/or programmable to implement multiple types of operations. Implementing the dedicated hardware modules 190a-190n may enable the hardware used to perform each type of calculation to be optimized for speed and/or efficiency. For example, the hardware modules 190a-190n may implement a number of relatively simple operations that are used frequently in computer vision operations that, together, may enable the computer vision operations to be performed in real-time. The video pipeline may be configured to recognize objects. Objects may be recognized by interpreting numerical and/or symbolic information to determine that the visual data represents a particular type of object and/or feature. For example, the number of pixels and/or the colors of the pixels of the video data may be used to recognize portions of the video data as objects. The hardware modules 190a-190n may enable computationally intensive operations (e.g., computer vision operations, video encoding, video transcoding, 3D reconstruction, depth map generation, liveness detection, etc.) to be performed locally by the ground truth acquisition device 100.

One of the hardware modules 190a-190n (e.g., 190a) may implement a scheduler circuit. The scheduler circuit 190a may be configured to store a directed acyclic graph (DAG). In an example, the scheduler circuit 190a may be configured to generate and store the directed acyclic graph in response to the feature set information received (e.g., loaded). The directed acyclic graph may define the video operations to perform for extracting the data from the video frames. For example, the directed acyclic graph may define various mathematical weighting (e.g., neural network weights and/or biases) to apply when performing computer vision operations to classify various groups of pixels as particular objects.

The scheduler circuit 190a may be configured to parse the acyclic graph to generate various operators. The operators may be scheduled by the scheduler circuit 190a in one or more of the other hardware modules 190a-190n. For example, one or more of the hardware modules 190a-190n may implement hardware engines configured to perform specific tasks (e.g., hardware engines designed to perform particular mathematical operations that are repeatedly used to perform computer vision operations). The scheduler circuit 190a may schedule the operators based on when the operators may be ready to be processed by the hardware engines 190a-190n.

The scheduler circuit 190a may time multiplex the tasks to the hardware modules 190a-190n based on the availability of the hardware modules 190a-190n to perform the work. The scheduler circuit 190a may parse the directed acyclic graph into one or more data flows. Each data flow may include one or more operators. Once the directed acyclic graph is parsed, the scheduler circuit 190a may allocate the data flows/operators to the hardware engines 190a-190n and send the relevant operator configuration information to start the operators.

Each directed acyclic graph binary representation may be an ordered traversal of a directed acyclic graph with descriptors and operators interleaved based on data dependencies. The descriptors generally provide registers that link data buffers to specific operands in dependent operators. In various embodiments, an operator may not appear in the directed acyclic graph representation until all dependent descriptors are declared for the operands.

One of the hardware modules 190a-190n (e.g., 190b) may implement an artificial neural network (ANN) module. The artificial neural network module may be implemented as a fully connected neural network or a convolutional neural network (CNN). In an example, fully connected networks are “structure agnostic” in that there are no special assumptions that need to be made about an input. A fully-connected neural network comprises a series of fully-connected layers that connect every neuron in one layer to every neuron in the other layer. In a fully-connected layer, for n inputs and m outputs, there are n*m weights. There is also a bias value for each output node, resulting in a total of (n+1)*m parameters. In an already-trained neural network, the (n+1)*m parameters have already been determined during a training process. An already-trained neural network generally comprises an architecture specification and the set of parameters (weights and biases) determined during the training process. In another example, CNN architectures may make explicit assumptions that the inputs are images to enable encoding particular properties into a model architecture. The CNN architecture may comprise a sequence of layers with each layer transforming one volume of activations to another through a differentiable function.

In the example shown, the artificial neural network 190b may implement a convolutional neural network (CNN) module. The CNN module 190b may be configured to perform the computer vision operations on the video frames. The CNN module 190b may be configured to implement recognition of objects through multiple layers of feature detection. The CNN module 190b may be configured to calculate descriptors based on the feature detection performed. The descriptors may enable the processor/SoC 106 to determine a likelihood that pixels of the video frames correspond to particular objects (e.g., a particular make/model/year of a vehicle, identifying a person as a particular individual, detecting a type of animal, detecting characteristics of a face, etc.).

The CNN module 190b may be configured to implement convolutional neural network capabilities. The CNN module 190b may be configured to implement computer vision using deep learning techniques. The CNN module 190b may be configured to implement pattern and/or image recognition using a training process through multiple layers of feature-detection. The CNN module 190b may be configured to conduct inferences against a machine learning model.

The CNN module 190b may be configured to perform feature extraction and/or matching solely in hardware. Feature points typically represent interesting areas in the video frames (e.g., corners, edges, etc.). By tracking the feature points temporally, an estimate of ego-motion of the capturing platform or a motion model of observed objects in the scene may be generated. In order to track the feature points, a matching operation is generally incorporated by hardware in the CNN module 190b to find the most probable correspondences between feature points in a reference video frame and a target video frame. In a process to match pairs of reference and target feature points, each feature point may be represented by a descriptor (e.g., image patch, SIFT, BRIEF, ORB, FREAK, etc.). Implementing the CNN module 190b using dedicated hardware circuitry may enable calculating descriptor matching distances in real time.

The CNN module 190b may be configured to perform face detection, face recognition and/or liveness judgment. For example, face detection, face recognition and/or liveness judgment may be performed based on a trained neural network implemented by the CNN module 190b. In some embodiments, the CNN module 190b may be configured to generate the depth image from the structured light pattern. The CNN module 190b may be configured to perform various detection and/or recognition operations and/or perform 3D recognition operations.

The CNN module 190b may be a dedicated hardware module configured to perform feature detection of the video frames. The features detected by the CNN module 190b may be used to calculate descriptors. The CNN module 190b may determine a likelihood that pixels in the video frames belong to a particular object and/or objects in response to the descriptors. For example, using the descriptors, the CNN module 190b may determine a likelihood that pixels correspond to a particular object (e.g., a person, an item of furniture, a pet, a vehicle, etc.) and/or characteristics of the object (e.g., shape of eyes, distance between facial features, a hood of a vehicle, a body part, a license plate of a vehicle, a face of a person, clothing worn by a person, etc.). Implementing the CNN module 190b as a dedicated hardware module of the processor/SoC 106 may enable the apparatus 100 to perform the computer vision operations locally (e.g., on-chip) without relying on processing capabilities of a remote device (e.g., communicating data to a cloud computing service).

The computer vision operations performed by the CNN module 190b may be configured to perform the feature detection on the video frames in order to generate the descriptors. The CNN module 190b may perform the object detection to determine regions of the video frame that have a high likelihood of matching the particular object. In one example, the types of object(s) to match against (e.g., reference objects) may be customized using an open operand stack (enabling programmability of the processor/SoC 106 to implement various artificial neural networks defined by directed acyclic graphs each providing instructions for performing various types of object detection). The CNN module 190b may be configured to perform local masking to the region with the high likelihood of matching the particular object(s) to detect the object.

In some embodiments, the CNN module 190b may determine the position (e.g., 3D coordinates and/or location coordinates) of various features (e.g., the characteristics) of the detected objects. In one example, the location of the arms, legs, chest and/or eyes of a person may be determined using 3D coordinates. One location coordinate on a first axis for a vertical location of the body part in 3D space and another coordinate on a second axis for a horizontal location of the body part in 3D space may be stored. In some embodiments, the distance from the lenses 160a and 160b may represent one coordinate (e.g., a location coordinate on a third axis) for a depth location of the body part in 3D space. Using the location of various body parts in 3D space, the processor/SoC 106 may determine body position, and/or body characteristics of detected people.

The CNN module 190b may be pre-trained (e.g., configured to perform computer vision to detect objects based on the training data received to train the CNN module 190b). For example, the results of training data (e.g., a machine learning model) may be pre-programmed and/or loaded into the processor/SoC 106. The CNN module 190b may conduct inferences against the machine learning model (e.g., to perform object detection). The training may comprise determining weight values for each layer of the neural network model. For example, weight values may be determined for each of the layers for feature extraction (e.g., a convolutional layer) and/or for classification (e.g., a fully connected layer). The weight values learned by the CNN module 190b may be varied according to the design criteria of a particular implementation.

The CNN module 190b may implement the feature extraction and/or object detection by performing convolution operations. The convolution operations may be hardware accelerated for fast (e.g., real-time) calculations that may be performed while consuming low power. In some embodiments, the convolution operations performed by the CNN module 190b may be utilized for performing the computer vision operations. In some embodiments, the convolution operations performed by the CNN module 190b may be utilized for any functions performed by the processor/SoC 106 that may involve calculating convolution operations (e.g., 3D reconstruction).

The convolution operation may comprise sliding a feature detection window along the layers while performing calculations (e.g., matrix operations). The feature detection window may apply a filter to pixels and/or extract features associated with each layer. The feature detection window may be applied to a pixel and a number of surrounding pixels. In an example, the layers may be represented as a matrix of values representing pixels and/or features of one of the layers and the filter applied by the feature detection window may be represented as a matrix. The convolution operation may apply a matrix multiplication between the region of the current layer covered by the feature detection window. The convolution operation may slide the feature detection window along regions of the layers to generate a result representing each region. The size of the region, the type of operations applied by the filters and/or the number of layers may be varied according to the design criteria of a particular implementation.

Using the convolution operations, the CNN module 190b may compute multiple features for pixels of an input image in each extraction step. For example, each of the layers may receive inputs from a set of features located in a small neighborhood (e.g., region) of the previous layer (e.g., a local receptive field). The convolution operations may extract elementary visual features (e.g., such as oriented edges, end-points, corners, etc.), which are then combined by higher layers. Since the feature extraction window operates on a pixel and nearby pixels (or sub-pixels), the results of the operation may have location invariance. The layers may comprise convolution layers, pooling layers, non-linear layers and/or fully connected layers. In an example, the convolution operations may learn to detect edges from raw pixels (e.g., a first layer), then use the feature from the previous layer (e.g., the detected edges) to detect shapes in a next layer and then use the shapes to detect higher-level features (e.g., facial features, pets, vehicles, components of a vehicle, furniture, etc.) in higher layers and the last layer may be a classifier that uses the higher level features.

The CNN module 190b may execute a data flow directed to feature extraction and matching, including two-stage detection, a warping operator, component operators that manipulate lists of components (e.g., components may be regions of a vector that share a common attribute and may be grouped together with a bounding box), a matrix inversion operator, a dot product operator, a convolution operator, conditional operators (e.g., multiplex and demultiplex), a remapping operator, a minimum-maximum-reduction operator, a pooling operator, a non-minimum, non-maximum suppression operator, a scanning-window based non-maximum suppression operator, a gather operator, a scatter operator, a statistics operator, a classifier operator, an integral image operator, comparison operators, indexing operators, a pattern matching operator, a feature extraction operator, a feature detection operator, a two-stage object detection operator, a score generating operator, a block reduction operator, and an upsample operator. The types of operations performed by the CNN module 190b to extract features from the training data may be varied according to the design criteria of a particular implementation.

One or more of the hardware modules 190a-190n may be configured to implement other types of AI models. In one example, the hardware modules 190a-190n may be configured to implement an image-to-text AI model and/or a video-to-text AI model. In another example, the hardware modules 190a-190n may be configured to implement a Large Language Model (LLM). Implementing the AI model(s) using the hardware modules 190a-190n may provide AI acceleration that may enable complex AI tasks to be performed on an edge device such as the edge devices 100a-100n.

One of the hardware modules 190a-190n may be configured to perform the virtual aperture imaging. One of the hardware modules 190a-190n may be configured to perform transformation operations (e.g., FFT, DCT, DFT, etc.). The number, type and/or operations performed by the hardware modules 190a-190n may be varied according to the design criteria of a particular implementation.

Each of the hardware modules 190a-190n may implement a processing resource (or hardware resource or hardware engine). The hardware engines 190a-190n may be operational to perform specific processing tasks. In some configurations, the hardware engines 190a-190n may operate in parallel and independent of each other. In other configurations, the hardware engines 190a-190n may operate collectively among each other to perform allocated tasks. One or more of the hardware engines 190a-190n may be homogeneous processing resources (all circuits 190a-190n may have the same capabilities) or heterogeneous processing resources (two or more circuits 190a-190n may have different capabilities).

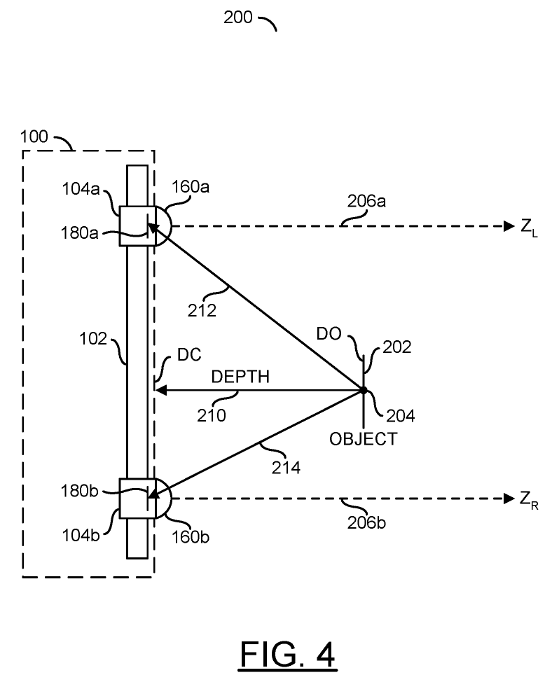

Referring to FIG. 4, a diagram illustrating ground truth acquisition device calibration is shown. A scenario 200 is shown. The scenario 200 may comprise the camera (or capture device) 104a, the camera (or capture device) 104b, and an object 202. In an example, the object 202 may comprise a checkerboard or other calibration pattern (e.g., corners, circles, etc.). The chassis structure (or camera mount) 102, the camera 104a with the lens 160a, and the camera 104b with the lens 160b are shown. Other components of the ground truth acquisition device 100 have been omitted for clarity.

A location DC is shown at the ground truth acquisition device 100. The location DC may represent a baseline location of the lens 160a and the lens 160b. A location DO is shown. The location DO may represent a distance of the object 202 from the baseline location DC of the ground truth acquisition device 100. In an example, the object 202 may be a distance of DO from the ground truth acquisition device 100.

The object 202 is shown at the distance DO from the baseline location DC. The object 202 is shown at some location in-between the lens 160a and the lens 160b. For example, the object 202 is shown offset from both the lens 160a and the lens 160b. In an example, the object 202 may comprise a checkerboard or other calibration pattern (e.g., corners, circles, etc.) that allows the object 202 to have a slight appearance difference in the images captured by the cameras 104a and 104b. The type, size, shape, distance from the ground truth acquisition device 100 and/or distance from the object 202 may be varied according to the design criteria of a particular implementation.

A line 206a is shown. The line 206a may represent the optical axis of the camera 104a. A line 206b is shown. The line 206b may represent the optical axis of the camera 104b. A line 210 is shown. The line 210 may represent a baseline depth of the ground truth acquisition device 100 from the object 202. The line 210 may illustrate a depth direction. A line 212 is shown. The line 212 may represent an image of a point 204 on the object 202 captured by the image sensor 180a with respect to the object 202 and a depth direction of the object 202. A line 214 is shown. The line 214 may represent an image of a point 204 on the object 202 captured by the image sensor 180b with respect to the object 202 and a depth direction of the object 202.

The chassis structure 102 is generally configured such that when the cameras 104a and 104b are mounted to the chassis structure 102, the optical axis 206a of the camera 104a and the optical axis 206b of the camera 104b are substantially parallel. Furthermore, when the cameras 104a and 104b are mounted on the chassis structure 102, the image sensor 180a of the camera 104a and the image sensor 180b of the camera 104b are generally coplanar. The cameras 104a and 104b are mounted on a common horizontal (X) axis with a predetermined separation distance. The cameras 104a and 104b are generally mounted having a minimal vertical offset from each other. Any vertical offset between the cameras 104a and 104b is generally compensated by a calibration process in accordance with an embodiment of the invention.

In various embodiments, the chassis structure 102 provides a mechanical mount that ensures the differences in the three rotation directions YAW/PITCH/ROLL are very small before the stereo calibration process is performed. The stereo calibration process generally determines the remaining small differences and computes the warm parameters for compensating for the small differences to substantially align the captured images generated by the cameras 104a and 104b. In an example, the images may be aligned to within one pixel or better.

In an example, a point 204 on the object 202 may appear at a different point in the images captured by the cameras 104a and 104b. A disparity map may be created based on the difference between the position of the point 204 in an image captured by the camera 104a and the position of the point 204 in an image captured by the camera 104b. In an example, parallax error is generally more pronounce when the object 202 is closer to the ground truth acquisition device 100 than when the object 202 is farther from the ground truth acquisition device 100. In general, the disparity values obtained from the captured images are directly proportional to the distance between the cameras 104a and 104b, and inversely proportional to the distance DO from the baseline location DC.

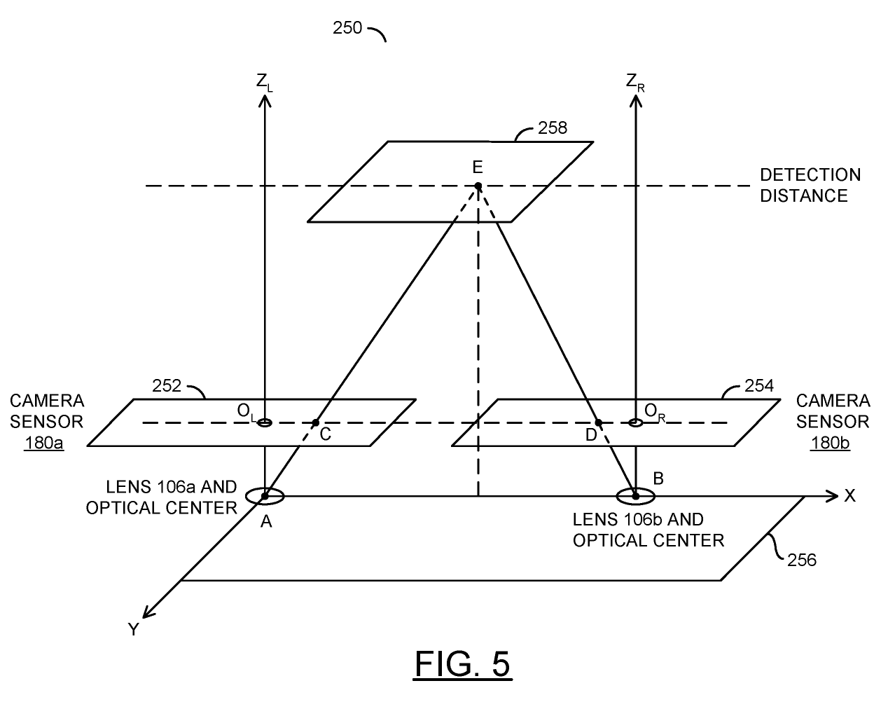

Referring to FIG. 5, a diagram is shown illustrating disparity determination for a ground truth acquisition device in accordance with an example embodiment of the invention. A scenario 250 is shown. In an example, a rectangular plane 252 of the camera sensor 180a and a rectangular plane 254 of the camera sensor 180b may be substantially coplanar and parallel to an XY plane 256 containing the lens 160a of the camera 104a and the lens 160b of the camera 104b. A pixel row of the sensor 180a and a pixel row of the sensor 180b (e.g., represented by a dashed line) may be aligned with the X-axis direction. A point A may be used to represent the optical center of the lens 160a and a point B may be used to represent the optical center of the lens 160b. A point E may be used to represent a feature on the object 202 at different distances to the ground truth acquisition device 100. The point E may be captured by the camera sensor 180a at a point C and by the camera sensor 180b at a point D. A point where the optical axis of the camera 104a intersects the plane 252 may be captured by the camera sensor 180a at a point O_{L}. A point where the optical axis of the camera 104b intersects the plane 254 may be captured by the camera sensor 180b at a point O_{R}. In an example, the disparity value is generally defined as the difference in length between the line CO_{L} and the line DO_{R}.

A plane ABE is generally defined by the three points A, B, and E. The plane ABE intersects the plane 252 of the image sensor 180a along the pixel row containing the disparity line CO_{L}, intersects the plane 254 of the image sensor 180b along the pixel row containing the disparity line CO_{R}, and intersects the plane 256 at the X-axis. Because the plane ABE intersects the plane 252 of the image sensor 180a along the pixel row containing the disparity line CO_{L}, intersects the plane 254 of the image sensor 180b along the pixel row containing the disparity line CO_{R}, and intersects the plane 256 at the X-axis, the disparity lines CO_{L} and CO_{R} are always parallel to the X-axis. The relative pose T=[R t] of the camera coordinate system of the camera 104b relative to the camera coordinate system of the camera 104a may be determined using extrinsic parameter calibration.

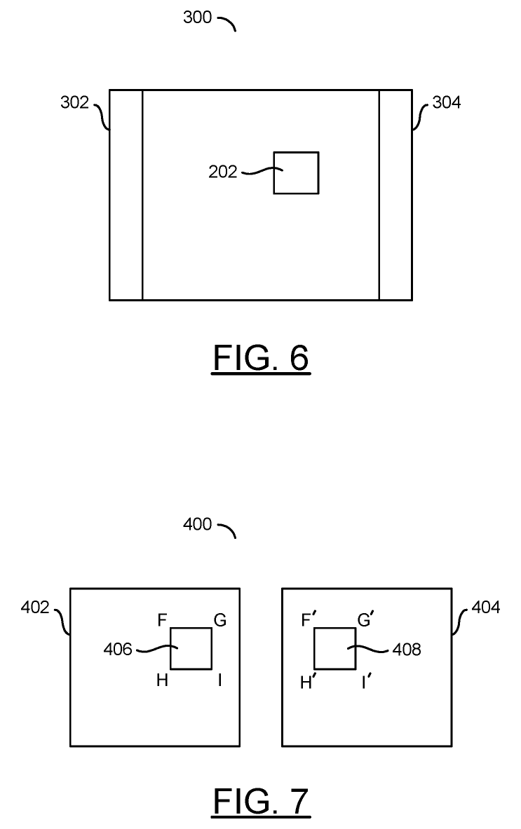

Referring to FIG. 6, a diagram is shown illustrating an object being imaged by cameras of a ground truth acquisition device in accordance with embodiments of the invention. A scenario 300 is shown. The scenario 300 may comprise a frame 302 captured by the camera (or capture device) 104a, a frame 304 captured by the camera (or capture device) 104b, and the object 202. In an example, the object 202 may appear at different spots in the frames 302 and 304. In various embodiments, aligning adjacent frames together may be accomplished using a method or combination of methods. In an example, a spatial transformation (warping) of quadrilateral regions may be used. First, a number of image registration points may be determined. For example, fixed points may be imaged at known locations in each of the frames 302 and 304. In either case a calibration process involves pointing the cameras 104a and 104b at a known, structured scene and finding corresponding points.

For example, FIG. 6 illustrates views of two cameras trained on a scene that includes the rectangular object (or target) 202. In an example, the object 202 may be implemented as a chessboard, checkerboard, or circle calibration board. The object 202 is generally placed in an area of overlap between a field-of-view of the camera 104a and a field-of-view of the camera 104b. In an example, the corners of the rectangular object 202 may constitute image registration points (e.g., points in common to views of each of the cameras 104a and 104b). In an embodiment where the object 202 comprises a chessboard or circle calibration board, chessboard or circle detectors may be used to obtain the image registration points.

Referring to FIG. 7, a diagram is shown illustrating the object 202 as captured in frames obtained from the cameras 104a and 104b of the ground truth acquisition device 100. A scenario 400 is shown. In the scenario 400 frames 402 and 404 of the two cameras 104a and 104b are shown. The object 202 may be captured as a quadrilateral area 406 having corners F, G, H, and I in the frame 402, and as a quadrilateral area 408 having corners F', G', H', and I' in the frame 404. Because of the slightly different camera angles, the quadrilateral areas 406 and 408 are not consistent in angular construction and are generally captured in different locations with respect to other objects in the image. In an example, the frames may be matched (aligned) by warping each of the quadrilateral regions 406 and 408 into a common coordinate system. Note that the sides of quadrilateral areas 406 and 408 are shown as straight, but may actually be subject to some barrel or pincushion distortion, which may also be approximately corrected via warping operations. In an example, barrel/pincushion distortion may be corrected using radial (rather than piecewise linear) transforms. Piecewise linear transforms may fix an approximation of the curve.

In another example, only one of the images may be warped to match a coordinate system of the other image. For example, warping of quadrilateral area 406 may be performed via a perspective transformation. Thus quadrilateral 406 in frame 402 may be transformed to quadrilateral 408 in the coordinate system of frame 404.

Camera arrays generally have a small but significant baseline separation. This may be a problem when combining images of objects at different distances from the baseline, as a single warping function will only work perfectly for one particular distance. Images of objects not at that distance may be warped into different places and may appear doubled ("ghosted") or truncated when the images are merged.

In various embodiments, a camera array may be calibrated such that objects at a particular distance, or images of smooth backgrounds, may be combined with no visible disparity. A minimum disparity may be found by determining how much to shift one image to match the other. Because images are warped into corresponding squares, all that is necessary is to find a particular shift that matches the corresponding squares.

A ground truth acquisition device in accordance with embodiments of the invention generally comprises two video cameras arranged in a spaced apart array, so as to collectively capture a particular field of view. The ground truth acquisition device may also include a processor circuit configured to receive each stream of digital or analog output from the two cameras simultaneously. The processor circuit may be configured to synchronize the exposure times of the two cameras (e.g., using a frame synchronization signal) and process the collection of signals, so as to remove any distortion created by the image capture process, to accurately overlay the two images of the two adjacent cameras 104a and 104b.

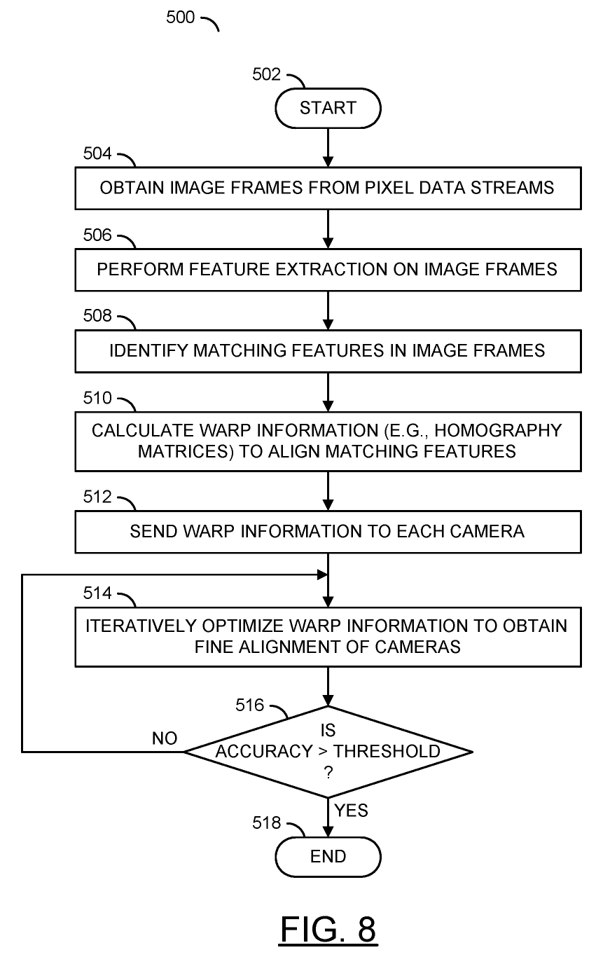

Referring to FIG. 8, a diagram is shown illustrating a calibration process 500 in accordance with embodiments of the invention. In various embodiments, the calibration process 500 receives input image frames from the cameras 104a and 104b (e.g., via the pixel data streams). The process 500 may also receive the intrinsic parameters and distortion parameters for each of the cameras 104a and 104b. In an example embodiment, the calibration process (or method) 500 comprises a step (or state) 502, a step (or state) 504, a step (or state) 506, a step (or state) 508, a step (or state) 510, a step (or state) 512, a step (or state) 514, a step (or state) 516, and a step (or state) 518. The calibration process 500 generally begins in the step 502 and moves to the step 504.

In the step 504, the process 500 may obtain image frames from the cameras 104a and 104b. Exposure times of the cameras 104a and 104b are generally synchronized by a frame synchronization signal presented to both of the cameras 104a and 104b. In an example, the images frames may comprise images of a flat and rigid calibration board placed at a distance from the ground truth acquisition device 100. In an example, the calibration board may be placed in a position to appear in the respective fields-of-view (FOVs) of the (left) camera 104a and the (right) camera 104b.

In the step 506, the process 500 may perform feature extraction to detect a plurality of features in each of the left image frame and the right image frame. In an example, a circle or chessboard detector may be used to detect a circle center or a corner on the calibration board. In the step 508, the process 500 may identify matching features in each of the left image frame and the right image frame. In general, a detected point in one view should be matched in the other view.

In the step 510, the process 500 may perform extrinsic calibration for each of the cameras 104a and 104b, using intrinsic parameters (e.g., fx, fy, cx, cy, etc.) and distortion parameters (e.g., k1, k2, k3, p1, p2, etc.) for the cameras 104a and 104b. In an example, the intrinsic parameters and the distortion parameters may be obtained from separate lens calibration procedures performed independently on the cameras 104a and 104b. In an example, the extrinsic calibration for the cameras 104a and 104b generally calculates warp information (e.g., extrinsic parameters, homography matrices, etc.) that may be used by the cameras 104a and 104b to align the matching features. In an example, the warp information may include, but is not limited to, a rotation matrix (e.g., R₃ₓ₃) and a translation vector (e.g., T₃ₓ₁). In general, the warp information may be determined using common stereo calibration techniques.

In the step 512, the process 500 generally communicates respective warp information to the left camera 104a and the right camera 104b. The cameras 104a and 104b then apply the respective warp information to the raw image data prior to communicating the image data to the ground truth acquisition system 100. In an example, the respective warp information may be applied to the raw image data using image processing pipelines within the cameras 104a and 104b. By applying the respective warp information to the raw image data using image processing pipelines within the cameras 104a and 104b, the image frames obtained by the ground truth acquisition system 100 are generally aligned and ready for determining disparity. The corresponding image may be warped with the homography matrix.

In the step 514, an iterative process maybe performed to optimize the warp information to obtain a fine alignment of the cameras 104a and 104b. In the step 516, the process 500 may check whether the alignment of the image frames meets a predetermined threshold. If the alignment of the image frames does not meet the predetermined threshold, the process 500 may return to the stem 514. When the alignment of the image frames meets the predetermined threshold, the process 500 may move to the stem 518 and terminate.

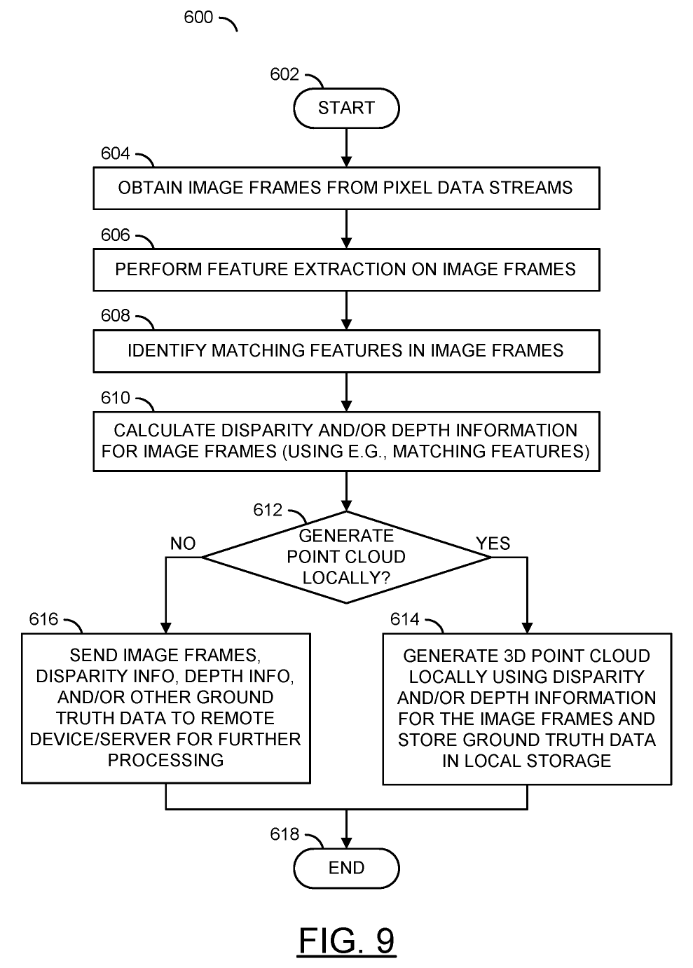

Referring to FIG. 9, a diagram is shown illustrating a ground truth data acquisition process 600 in accordance with embodiments of the invention. In various embodiments, the ground truth acquisition device 100 may provide ground truth data that may be used for scene reconstruction. In an example, the ground truth data may be utilized using a Simultaneous Localization and Mapping (SLAM) algorithm. In an example, the SLAM algorithm may be implemented locally or remotely (e.g., on a remote computer/server). In an example, the ground truth data acquisition process 600 may be implemented (executed) on the processor/S0C 106. In an example embodiment, the ground truth data acquisition process (or method) 600 comprises a step (or state) 602, a step (or state) 604, a step (or state) 606, a step (or state) 608, a step (or state) 610, a step (or state) 612, a step (or state) 614, a step (or state) 616, and a step (or state) 618. The ground truth data acquisition process 600 generally begins in the step 602 and moves to the step 604.

In the step 604, the ground truth data acquisition process 600 may obtain image frames from a first monocular ADAS camera and a second monocular ADAS camera. The first monocular ADAS camera and the second monocular ADAS camera are generally mounted on a chassis structure configured to roughly align the optical axes of the first monocular ADAS camera and the second monocular ADAS camera. The first monocular ADAS camera and the second monocular ADAS camera are generally configured to apply respective warp information to the raw image data collected by the first monocular ADAS camera and the second monocular ADAS camera. In step 606, the ground truth data acquisition process 600 may perform feature extraction on the image frames obtained from the first monocular ADAS camera and the second monocular ADAS camera. In the step 608, the ground truth data acquisition process 600 may identify matching features in the image frames obtained from the first monocular ADAS camera and the second monocular ADAS camera. In the step 610, the ground truth data acquisition process 600 may calculate disparity and/or depth information for the image frames using the features extracted.

In the step 612, the ground truth data acquisition process 600 may determine whether a three-dimensional (3D) point cloud is to be generated locally or on a remote device/server. When the ground truth data acquisition process 600 is to generate the 3D point cloud locally, the ground truth data acquisition process 600 moves to the step 614. When the ground truth data acquisition process 600 is to generate the 3D point cloud remotely, the ground truth data acquisition process 600 moves to the step 616. In the step 614, the ground truth data acquisition process 600 generates the 3D point cloud locally using the disparity and/or depth information calculated for the image frames and stores the 3D point cloud in the memory 108. The ground truth data acquisition process 600 then moves to the step 618 and terminates. In the step 616, the ground truth data acquisition process 600 may communicate the image frames, the disparity and/or depth information calculated for the image frames, and other ground truth information and/or metadata to the remote device or server. The ground truth data acquisition process 600 then moves to the step 618 and terminates. The remote device or server may generate the 3D point cloud using the disparity and/or depth information calculated for the image frames and/or perform other post-processing using the information received from the ground truth data acquisition device 100.

In various embodiments, a ground truth acquisition device (or system) may be implemented that provides various cost advantages. In an example, the ground truth data collection process in accordance with an embodiment of the invention may avoid using LiDAR, which significantly reduces costs. In an example, the ground truth data collection process in accordance with an embodiment of the invention may provide a denser point cloud than LiDAR, which may largely replace LiDAR. In an example, the finally generated three-dimensional (3D) point cloud data is generally enough for the monocular ADAS algorithm to be used as ground truth for algorithm training. In various embodiments, a ground truth acquisition device may be implemented that eliminates a need to make major modifications to the monocular ADAS equipment. In general, ADAS cameras may be considered unchanged physically, and only the software is slightly modified.

In various embodiments, a ground truth acquisition device may be implemented that also provides various performance advantages. Compared with ADAS that does not use the ground truth system, the data provided may have a significant effect on improving the distance accuracy of the ADAS algorithm. Binocular stereo vision plus post-processing may detect untrained targets and establish an occupancy grid, which may be of value for monocular ADAS algorithm design and testing the detection and classification of untrained targets on the road. Binocular stereo vision detection of road curbs in the scene also may be very useful. In an example, detection of road curbs in the scene may facilitate the improvement of monocular vision ADAS algorithms, especially for bumps and dips in the road. In addition, the ground truth acquisition device in accordance with an embodiment of the invention may facilitate the data collection of ADAS devices. In an example, the ground truth acquisition device in accordance with an embodiment of the invention may add precise world time, IMU information, and other information, which may enable more accurate scene reconstruction in post processing.

The functions performed by the diagrams of FIGS. 1-9 may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU), video digital signal processor (VDSP) and/or similar computational machines, programmed according to the teachings of the specification, as will be apparent to those skilled in the relevant art(s). Appropriate software, firmware, coding, routines, instructions, opcodes, microcode, and/or program modules may readily be prepared by skilled programmers based on the teachings of the disclosure, as will also be apparent to those skilled in the relevant art(s). The software is generally executed from a medium or several media by one or more of the processors of the machine implementation.

The invention may also be implemented by the preparation of ASICs (application specific integrated circuits), Platform ASICs, FPGAs (field programmable gate arrays), PLDs (programmable logic devices), CPLDs (complex programmable logic devices), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The invention thus may also include a computer product which may be a storage medium or media and/or a transmission medium or media including instructions which may be used to program a machine to perform one or more processes or methods in accordance with the invention. Execution of instructions contained in the computer product by the machine, along with operations of surrounding circuitry, may transform input data into one or more files on the storage medium and/or one or more output signals representative of a physical object or substance, such as an audio and/or visual depiction. Execution of instructions contained in the computer product by the machine, may be executed on data stored on a storage medium and/or user input and/or in combination with a value generated using a random number generator implemented by the computer product. The storage medium may include, but is not limited to, any type of disk including floppy disk, hard drive, magnetic disk, optical disk, CD-ROM, DVD and magneto-optical disks and circuits such as ROMs (read-only memories), RAMs (random access memories), EPROMs (erasable programmable ROMs), EEPROMs (electrically erasable programmable ROMs), UVPROMs (ultra-violet erasable programmable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, cloud servers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, audio storage and/or audio playback devices, video recording, video storage and/or video playback devices, game platforms, peripherals and/or multi-chip modules. Those skilled in the relevant art(s) would understand that the elements of the invention may be implemented in other types of devices to meet the criteria of a particular application.

The terms “may” and “generally” when used herein in conjunction with “is(are)” and verbs are meant to communicate the intention that the description is exemplary and believed to be broad enough to encompass both the specific examples presented in the disclosure as well as alternative examples that could be derived based on the disclosure. The terms “may” and “generally” as used herein should not be construed to necessarily imply the desirability or possibility of omitting a corresponding element.

The designations of various components, modules and/or circuits as “a”-“n”, when used herein, disclose either a singular component, module and/or circuit or a plurality of such components, modules and/or circuits, with the “n” designation applied to mean any particular integer number. Different components, modules and/or circuits that each have instances (or occurrences) with designations of “a”-“n” may indicate that the different components, modules and/or circuits may have a matching number of instances or a different number of instances. The instance designated “a” may represent a first of a plurality of instances and the instance “n” may refer to a last of a plurality of instances, while not implying a particular number of instances.

While the invention has been particularly shown and described with reference to embodiments thereof, it will be understood by those skilled in the art that various changes in form and details may be made without departing from the scope of the invention.

1. An apparatus comprising:
a chassis configured to be mounted to a vehicle and to hold a first ADAS camera and a second ADAS camera, wherein said chassis provides a coarse alignment of said first ADAS camera and said second ADAS camera to obtain stereo images of an area outside of said vehicle; and
a processor configured to (i) generate a frame synchronization signal based on a real-time clock signal, (ii) present said frame synchronization signal and one or more control signals to said first ADAS camera and said second ADAS camera, (iii) receive a first pixel datastream corresponding to said area outside of said vehicle from said first ADAS camera, (vi) receive a second pixel datastream corresponding to said area outside of said vehicle from said second ADAS camera, (v) process said first pixel datastream arranged as first video frames and said second pixel datastream arranged as second video frames, (vi) compute warp parameters for said first ADAS camera and said second ADAS camera to finely align pixel data of the first video frames with pixel data of the second video frames, and (vii) generate ground truth data based on said first video frames from said first ADAS camera and said second video frames from said second ADAS camera.

2. The apparatus according to claim 1, wherein said ground truth data comprises disparity data based on said first video frames and said second video frames.

3. The apparatus according to claim 1, wherein each of said first ADAS camera and said second ADAS camera comprise at least one of an RGB image sensor, an RGB-IR image sensor, a monochrome sensor, and an IR image sensor.

4. The apparatus according to claim 1, wherein respective intrinsic parameters of said first ADAS camera and said second ADAS camera match.

5. The apparatus according to claim 1, wherein:
said first ADAS camera comprises a first image processing pipeline configured to apply a first homography matrix to said first pixel datastream; and
said second ADAS camera match comprises a second image processing pipeline configured to apply a second homography matrix to said second pixel datastream, wherein said first homography matrix and said second homography matrix are configured to align pixel data generated by said first ADAS camera and said second ADAS camera to enable disparity calculation.

6. The apparatus according to claim 1, further comprising an inertial measurement unit configured to generate one or more signals representative of motion of said vehicle.

7. The apparatus according to claim 1, further comprising a GNSS/GPS device to generate said real-time clock signal.

8. The apparatus according to claim 7, wherein said ground truth data comprises location information provided by said GNSS/GPS device.

9. The apparatus according to claim 1, wherein said chassis is configured to be mounted behind an inside surface of a windshield of said vehicle.

10. The apparatus according to claim 1, wherein said chassis is configured to be mounted to an exterior surface of said vehicle.

11. A method for obtaining ground truth data for scene reconstruction comprising:
mounting a chassis to a vehicle, wherein said chassis is configured to hold a first ADAS camera and a second ADAS camera, and said chassis provides a coarse alignment of said first ADAS camera and said second ADAS camera to obtain stereo images of an area outside of said vehicle;
generating a frame synchronization signal based on a real-time clock signal;
presenting said frame synchronization signal and one or more control signals to said first ADAS camera and said second ADAS camera;
receiving a first pixel datastream corresponding to said area outside of said vehicle from said first ADAS camera;
receiving a second pixel datastream corresponding to said area outside of said vehicle from said second ADAS camera;
processing said first pixel datastream arranged as first video frames and said second pixel datastream arranged as second video frames;
calculating warp parameters for said first ADAS camera and said second ADAS camera to finely align pixel data of the first video frames with pixel data of the second video frames;
presenting said warp parameters to said first ADAS camera and said second ADAS camera, wherein said first ADAS camera and said second ADAS camera apply said warp parameters to finely align pixel data of the first video frames with pixel data of the second video frames; and
generating ground truth data based on said first video frames from said first ADAS camera and said second video frames from said second ADAS camera.

12. The method according to claim 11, wherein said ground truth data comprises disparity data based on said first video frames and said second video frames.

13. The method according to claim 11, wherein each of said first ADAS camera and said second ADAS camera comprise at least one of an RGB image sensor, an RGB-IR image sensor, a monochrome sensor, and an IR image sensor.

14. The method according to claim 11, wherein respective intrinsic parameters of said first ADAS camera and said second ADAS camera match.

15. The method according to claim 11, further comprising:
applying a first homography matrix to said first pixel datastream using a first image processing pipeline of said first ADAS camera; and
applying a second homography matrix to said second pixel datastream using a second image processing pipeline of said second ADAS camera match, wherein said first homography matrix and said second homography matrix are configured to align pixel data generated by said first ADAS camera and said second ADAS camera to enable disparity calculation.

16. The method according to claim 11, further comprising obtaining one or more signals representative of motion of said vehicle using an inertial measurement unit.

17. The method according to claim 11, further comprising obtaining said real-time clock signal using a GNSS/GPS device.

18. The method according to claim 17, wherein said ground truth data comprises location information obtained using said GNSS/GPS device.

19. The method according to claim 11, further comprising mounting said chassis behind an inside surface of a windshield of said vehicle.

20. The method according to claim 11, further comprising mounting said chassis to an exterior surface of said vehicle.
